(19) United States
(12) Patent Application Publication
(10) Pub. No.: US 2013/0182017 A1
(43) Pub. Date: Jul. 18, 2013

(54) DEVICE AND METHOD FOR HIGH REFLECTANCE MULTI-STATE ARCHITECTURES

(71) Applicants: Alok Govil, Santa Clara, CA (US); Jennifer L. Gille, Menlo Park, CA (US); Russel A. Martin, Menlo Park, CA (US)

(72) Inventors: Alok Govil, Santa Clara, CA (US); Jennifer L. Gille, Menlo Park, CA (US); Russel A. Martin, Menlo Park, CA (US)

(73) Assignee: QUALCOMM MEMS TECHNOLOGIES, INC., San Diego, CA (US)

(21) Appl. No.: 13/350,982

(22) Filed: Jan. 16, 2012

(51) Int. Cl. G09G 5/10

(52) U.S. Cl. 345/690

(57) ABSTRACT

This disclosure provides systems, methods and apparatus for device and methods for high reflectance multi-state architectures. In one aspect, a display device can include a plurality of reflective pixels including subpixels. Each subpixel can be selectively switched among first, second, and third states, with each state having a different spectral reflectance. Each subpixel has a spectral reflectance associated with a first set of primary colors and with a second set of primary colors. At least one of the colors in the second set of primary colors can be different from the colors in the first set of primary colors. The first set of primary colors can include colors that combine to produce white. A combination of colors of the first set of primary colors can have a brightness that is higher than the brightness of the combination of colors of the second set of primary colors.

### TECHNICAL FIELD

This disclosure relates to devices and methods for high reflectance multi-state architectures for electromechanical systems.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

For reflective displays, there is generally a tradeoff between brightness of the reflected white light and color gamut (and/or color saturation) of the display. Color gamut generally can refer to the range of colors that can be produced by a display by mixing the light output from the individual display elements. Saturation generally can refer to the dominance of hue in the color and can be indicated, although not always so, by the narrowness (in wavelength) of the reflectance versus wavelength curve. Typically, a reflective display in which the display elements produce more saturated colors can produce a larger color gamut. However, reflective displays with more saturated colors and larger color gamuts tend to have lower brightness than reflective displays with less saturated colors. For example, more saturated colors often reflect less light than less saturated colors because the area under the reflectance curve tends to be less.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device. For example, the display device can include a plurality of reflective pixels with each reflective pixel including subpixels. In certain implementations, each subpixel can be configured to be selectively switched among a first state, a second state, and a third state. Each state can have a different spectral reflectance. For example, the subpixels can have spectral reflectances associated with a first set of primary colors and the subpixels can have spectral reflectances associated with a second set of primary colors. At least one of the colors in the second set of primary colors can be different from the colors in the first set of primary colors. The first set of primary colors can include complementary colors that combine to produce white. In certain implementations, a combination of colors of the first set of primary colors can have a brightness that is higher than a brightness of a combination of colors of the second set of primary colors.

In some implementations, the first set of primary colors can be selected to increase brightness of the display device as compared to the second set of primary colors. The second set of primary colors can be selected to increase the total color gamut of the display device as compared to the first set of primary colors alone. In some implementations, the color gamut of the second set of primary colors is greater than the color gamut of the first set of primary colors. For example, the brightness of the combination of the colors of the first set of primary colors can be greater than the brightness of the combination of the second set of primary colors by about 150% to 400%. As another example, the colors of the first set of primary colors can form a first color gamut and the colors of the second set of primary colors can form a second color gamut. The second color gamut can be larger than the first color gamut, for example, by about 150% to 500%. At least one color of the first set of primary colors in some implementations can lie outside the second color gamut.

In certain implementations of the display device, at least one pixel can include at least three or more subpixels. As one example, the first set of primary colors can include cyan, desaturated green, and orange. The subpixels in the first state and in the second state can have spectral reflectances associated with either the first or second set of primary colors. Each subpixel in the first state can have a different spectral reflectance associated with the first set of primary colors and each subpixel in the second state can have a spectral reflectance associated with the second set of primary colors. The subpixels in the third state can have spectral reflectances associated with black.

In the display device of some implementations, each reflective subpixel can include an interferometric modulator. The interferometric modulator can include a first reflector, an electrode spaced from the first reflector by a first distance, and a second reflector disposed between the first reflector and the electrode. The second reflector can be movable between a relaxed position, an actuated position, and a reverse-actuated position. When in the actuated position, the second reflector can be closer to the first reflector than when in the relaxed position. When in the reverse-actuated position, the second reflector can be farther from the first reflector than when in the relaxed position. In some implementations, when in the relaxed position, the interferometric modulator can reflect light associated with one of the colors of the first set of primary colors when the interferometric modulator is illuminated by broadband white light. When in the reverse-actuated position, the interferometric modulator can reflect light associated with one of the colors of the second set of primary colors when the interferometric modulator is illuminated by broadband white light. At least one color of the second set of primary colors can include a second order color in some implementations.

In certain implementations, the display device can further include a display, a processor, and a memory device. The display can include an array of the plurality of reflective pixels. The processor can be configured to communicate with the display and can be configured to process image data. The memory device also can be configured to communicate with the processor. The display device can further include a driver circuit configured to send at least one signal to the display. In addition, the display device can further include a controller configured to send at least a portion of the image data to the driver circuit. The display device of some implementations can further include an image source module configured to send the image data to the processor. The image source module can include at least one of a receiver, a transceiver, and a transmitter. The display device also can include an input device configured to receive input data and to communicate the input data to the processor.

Another innovative aspect of the subject matter described in this disclosure can be implemented in a display device including a plurality of reflective pixels with each reflective pixel including a plurality of tri-state means for reflecting three colors. The tri-state means can be configured to be selectively switched among a first state, a second state, and a third state. Each state can have a different color. The plurality of tri-state means can have colors associated with a first set of primary colors and the plurality of tri-state means can have colors associated with a second set of primary colors. At least one of the colors in the second set of primary colors can be different from the colors in the first set of primary colors. The first set of primary colors can include complementary colors that combine to produce white. A combination of the colors of the first set of primary colors can have a higher brightness than a combination of the colors of the second set of primary colors.

In some of these implementations, the first set of primary colors can be selected to increase brightness of the display device as compared to the second set of primary colors. Also, the second set of primary colors can be selected to increase color gamut of the display device as compared to the first set of primary colors. For example, the colors of the first set of primary colors can form a first color gamut and the colors of the second set of primary colors can form a second color gamut. The second color gamut can be larger than the first color gamut.

In certain implementations of the display device, when the tri-state means are in the first state, the display device can provide increased brightness relative to when the tri-state means are in the second state. In addition, when the tri-state means are in the second state, the display device can provide increased color gamut relative to when the tri-state means are in the first state. In some implementations, the plurality of tri-state means can include interferometric modulators.

Another innovative aspect of the subject matter described in this disclosure can be implemented in a method of generating an image with a display device. For example, the display device can include a plurality of reflective pixels. Each reflective pixel can include multiple subpixels configured to be selectively switched among a first state, a second state, and a third state. For each subpixel, one of the first, second, and third states can define a first set of primary colors and, for each subpixel, an other of the first, second, and third states can define a second set of primary colors. At least one of the colors in the second set of primary colors can be different from the colors in the first set of primary colors. A combination of the colors of the first set of primary colors can have a higher brightness than a combination of the colors of the second set of primary colors.

The method can include selectively switching the subpixels of a first pixel to output a color of the first set of primary colors to achieve a relatively bright output color. The method can further include selectively switching the subpixels of a second pixel to output a color of the second set of primary colors to achieve a color outside of the gamut of the first set of primary colors.

In certain implementations of the method, selectively switching the subpixels of the first pixel to the first state can provide increased bright white relative to selectively switching the subpixels of the second pixel to the second state. In some implementations, the first set of primary colors can include cyan, desaturated green, and orange. In addition, in some implementations, the subpixels in the third state can have spectral reflectances associated with black. At least one color of the second set of primary colors in some implementations can include a second order color.

Another innovative aspect of the subject matter described in this disclosure can be implemented in a method of fabricating a reflective pixel for a display device. For example, the reflective pixel can include multiple subpixels configured to be selectively switched among a first state, a second state, and a third state. One of the first, second, and third states for each of the subpixels can define a first set of primary colors. Also, an other of the first, second, and third states for each of the subpixels can define a second set of primary colors. At least one of the colors in the second set of primary colors can be different from the colors in the first set of primary colors. A combination of the colors of the first set of primary colors can have a higher brightness than a combination of the colors of the second set of primary colors. The method can include forming a first sacrificial layer over a substrate having an optical stack, forming a movable reflective layer over the first sacrificial layer, forming a second sacrificial layer over the movable reflective layer, and forming a bus stack over the second sacrificial layer.

In some implementations of the method of fabricating a reflective pixel, forming a first sacrificial layer can include using masks to form first sacrificial layers of different thicknesses for different subpixels in the reflective pixel. In addition, forming a second sacrificial layer can include using masks to form second sacrificial layers of different thicknesses for different subpixels in the reflective pixel. The method further can include removing the first sacrificial layer and the second sacrificial layer to provide gaps for each subpixel in the reflective pixel. In some implementations, forming the first sacrificial layer and forming the second sacrificial layer can include using six or fewer masks for all the gaps in the reflective pixel.

Another innovative aspect of the subject matter described in this disclosure can be implemented in a display device having an array of pixels. The array of pixels can include a first plurality of pixels having a first pixel design, and a second plurality of pixels having a second pixel design. The first pixel design can be configured to output a first color when the display device is in an off state. In addition, the second pixel design can be configured to output a second color different from the first color when the display device is in the off state.

In some such implementations, the first plurality of pixels and the second plurality of pixels can provide an off state image on the display device when the display device is in the off state. For example, the array can include a first region and a section region. The first region can include only the first plurality of pixels and the second region can include only the second plurality of pixels. In some implementations, the first plurality of pixels can have a first total color gamut and the second plurality of pixels can have a second total color gamut. The first total color gamut can substantially overlap with the second total color gamut. In various implementations, substantially no discernable effect of the off state image may remain when the display device is in the on state.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example color model.

FIG. 9B shows example spectral reflectances as a function of wavelength associated with three different hues.

FIG. 9C shows example spectral reflectances as a function of wavelength for two different colors.

FIG. 9D is an example chromaticity diagram that illustrates examples of colors that can be produced by a color display that includes red, green, and blue display elements.

FIGS. 10A-10C show schematic side cross-sectional views of an example multi-state interferometric modulator.

FIG. 11A schematically illustrates a side cross-sectional view of an example pixel including a plurality of subpixels.

FIG. 11B schematically illustrates a side cross-sectional view of an example pixel as shown in FIG. 11A.

FIG. 11C shows the spectral reflectances as a function of wavelength for the example pixel shown in FIG. 11B.

FIG. 11D shows the chromaticity diagram that illustrates the colors that can be produced by the example pixel shown in FIG. 11B.

FIG. 12A schematically illustrates a side cross-sectional view of an example pixel.

FIG. 12B shows the spectral reflectances as a function of wavelength for the example pixel shown in FIG. 12A.

FIG. 12C shows the chromaticity diagram that illustrates the colors that can be produced by the example pixel shown in FIG. 12A.

FIG. 13A schematically illustrates a side cross-sectional view of another example pixel.

FIG. 13B shows the spectral reflectances as a function of wavelength for the example pixel shown in FIG. 13A.

FIG. 13C shows the chromaticity diagram that illustrates the colors that can be produced by the example pixel shown in FIG. 13A.

FIG. 14A schematically illustrates a side cross-sectional view of another example pixel.

FIG. 14B shows the spectral reflectances as a function of wavelength for the example pixel shown in FIG. 14A.

FIG. 14C shows the chromaticity diagram that illustrates the colors that can be produced by the example pixel shown in FIG. 14A.

FIG. 15 shows an example display device.

FIG. 16A is an example method of generating an image with a display device.

FIG. 16B is an example method of fabricating a reflective pixel.

FIGS. 17A and 17B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (for example, video) or stationary (for example, still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (for example, display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a display device can be fabricated using a set of display elements such as spatial light modulating elements (for example, multi-state interferometric modulators). For example, the display device can include a set of reflective pixels with each reflective pixel having subpixels that can be selectively switched among three states. Each of the three states can have a spectral reflectance that is different from each of the other states. Each of the subpixels can have spectral reflectances associated with a first set of primary colors and a second set of primary colors. At least one of the colors in the second set of primary colors can be different from the colors in the first set of primary colors. The first set of primary colors can include colors that combine to produce white light and can achieve a brightness that is higher than a brightness achieved by using a combination of colors of the second set of primary colors. In addition, the second set of primary colors can contribute to a total color gamut that is larger than the color gamut achievable with the first set of primary colors alone. Thus, examples of multi-state architectures are provided that can achieve both high reflectance and high color gamut.

Particular implementations of the subject matter described in this disclosure can be implemented to realize one or more of the following potential advantages. For example, as discussed above, a reflective display in which the display elements produce more saturated colors can produce a larger color gamut. However, reflective displays with more saturated colors and larger color gamuts tend to have lower brightness than reflective displays with less saturated colors. For example, the total amount of light reflected by combining three highly saturated colors (such as three relatively narrow reflectance curves) to form white light would be generally less than the total amount of light reflected by combining three less saturated colors (such as three relatively broader reflectance curves). In addition, including additional colors within a subpixel often can reduce the subpixel's area of reflectance, which also can reduce brightness. Various implementations of a display device can include additional primary colors, including more saturated colors, within a subpixel without reducing the subpixel's area of reflectance, which would otherwise reduce brightness.

Thus, certain implementations can simultaneously achieve relatively higher reflectance/brightness, color gamut, and/or saturation than displays (such as reflective displays) including only subpixels associated with one set of primary colors. In some of these implementations, the first set of primary colors increases the brightness of the display device, while the second set of primary colors increases the color gamut of the display device. For example, the brightness of the combination of colors of the first set of primary colors can be up to 150% greater than the brightness of the combination of the second set of primary colors, and in some implementations, up to 400% greater. In addition, in some implementations, the second set of primary colors can have a color gamut up to 150% greater than the first color gamut, and in some implementations, up to 500% greater. In some other implementations, the second set of primary colors also can increase the color saturation of some of the colors output by the display device as compared to a display device including only subpixels associated with the first set of primary colors.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

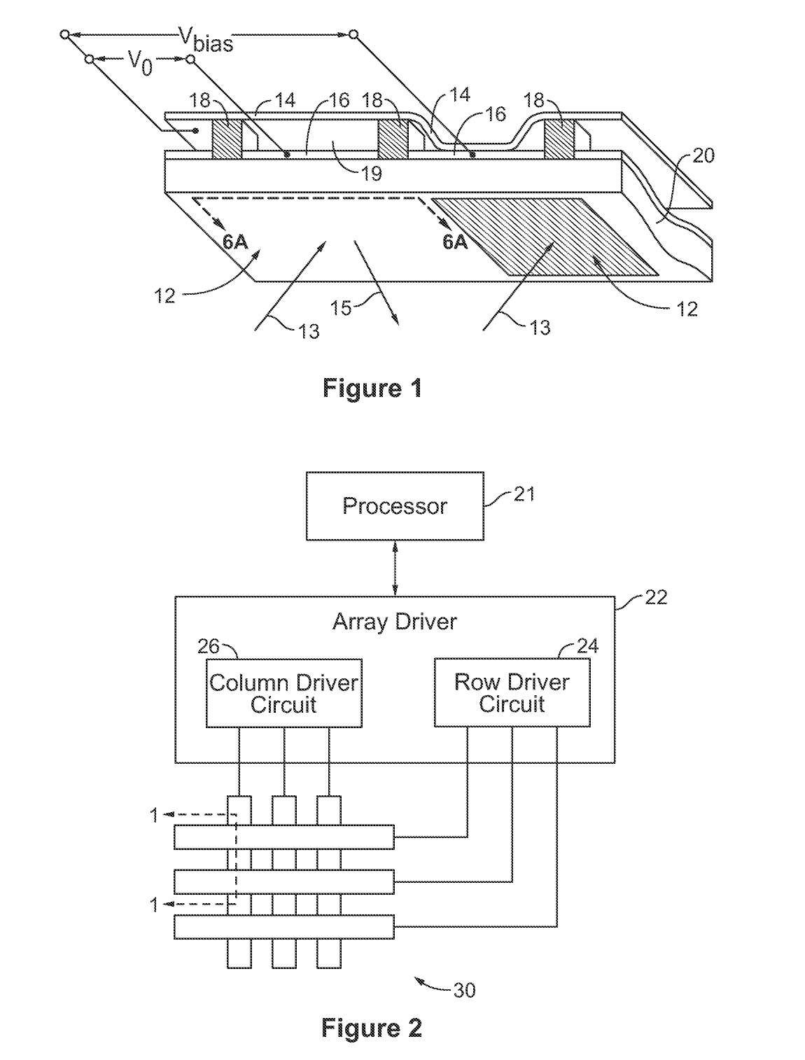

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, for example, to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (for example, of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1,000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

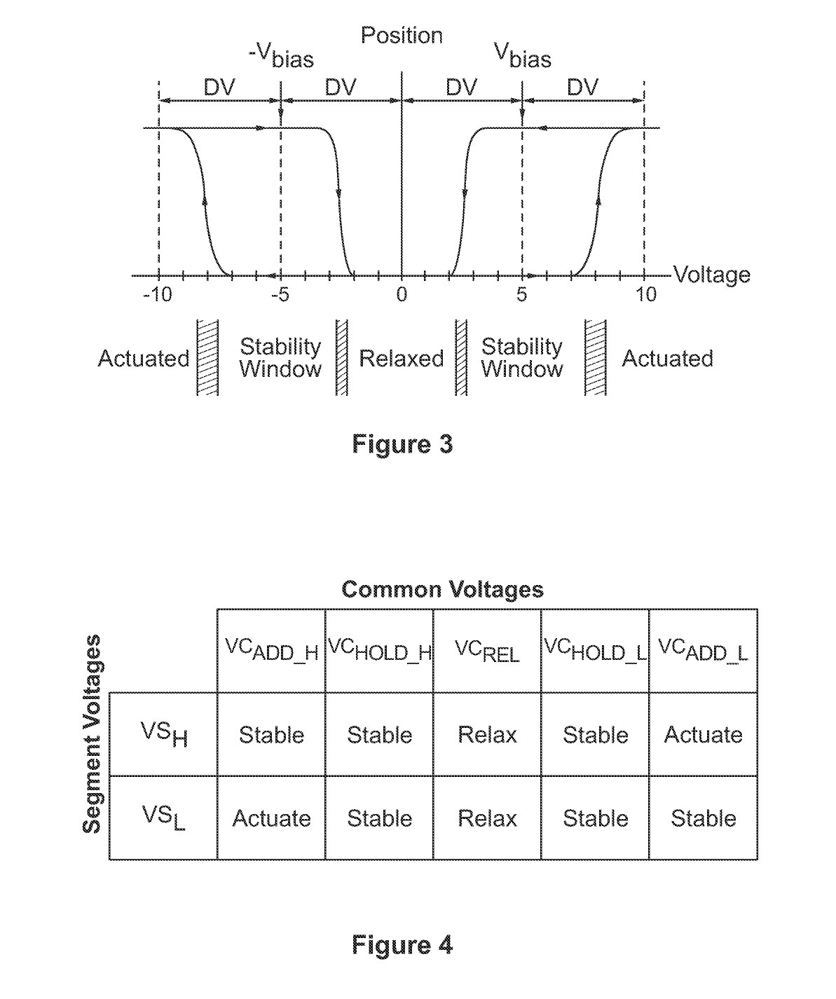

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

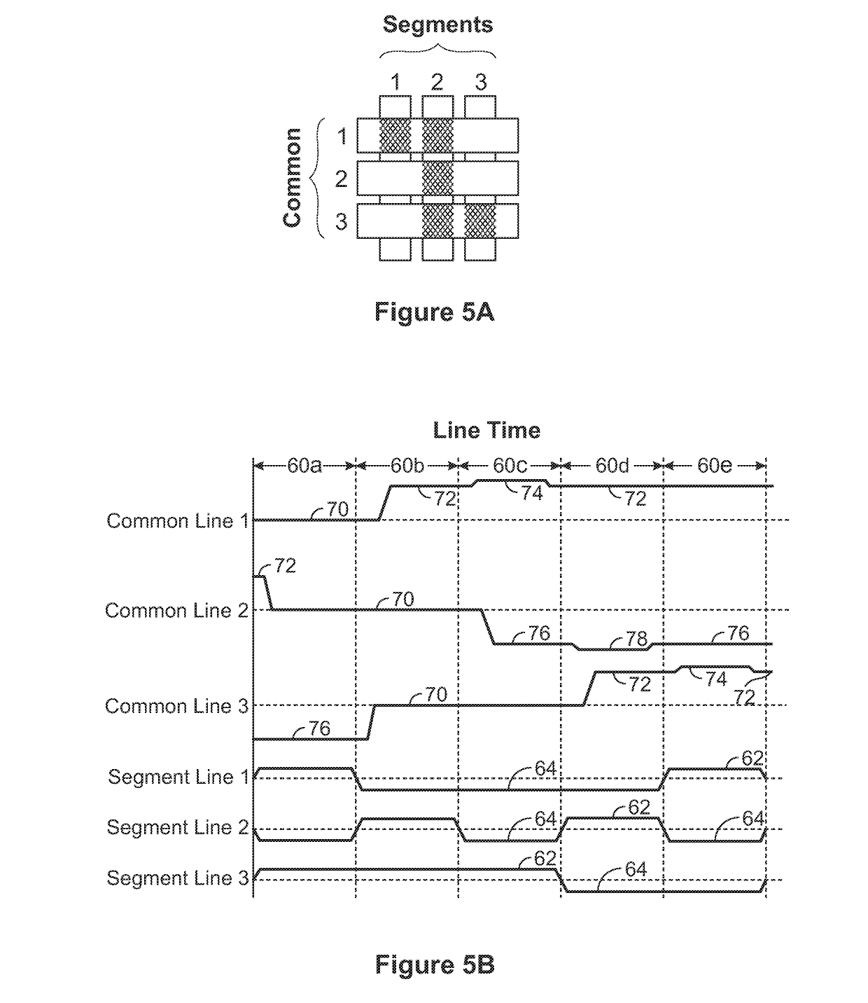

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

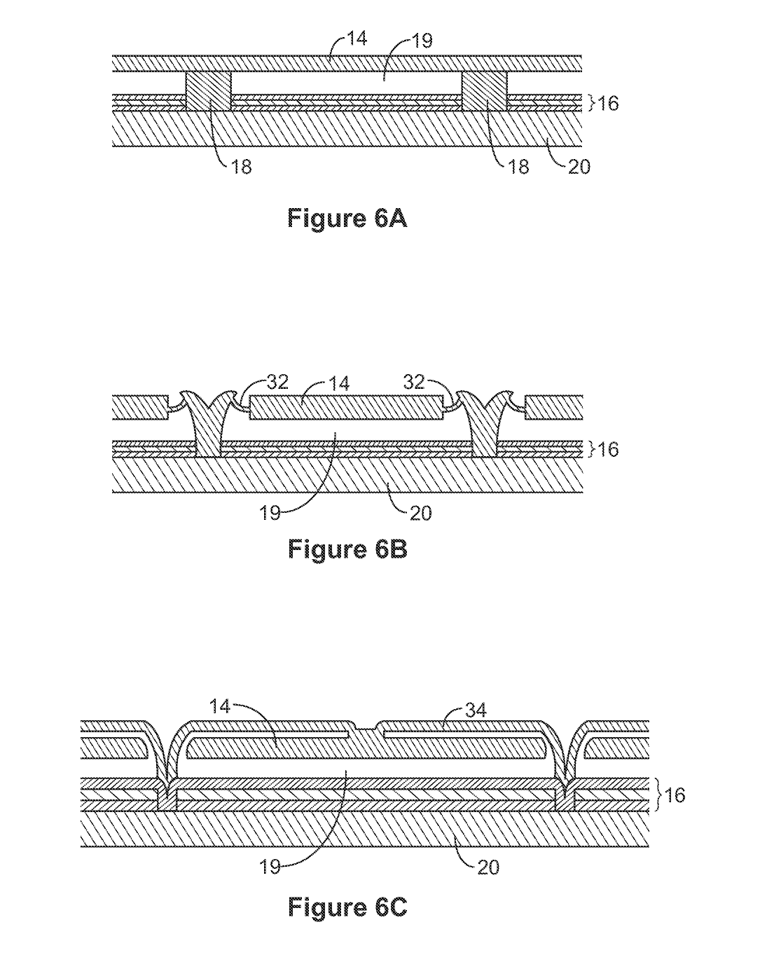

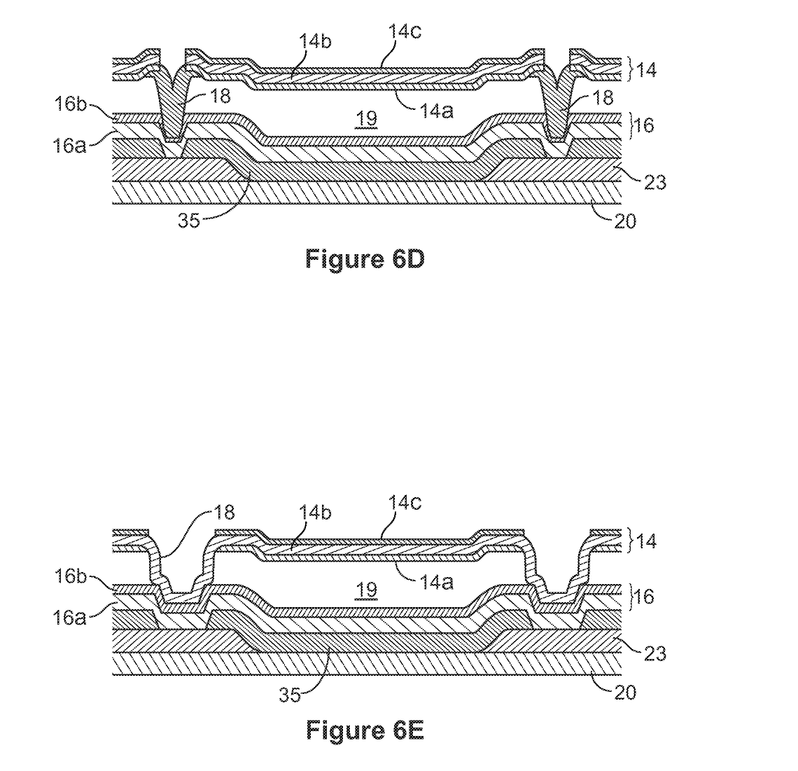

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

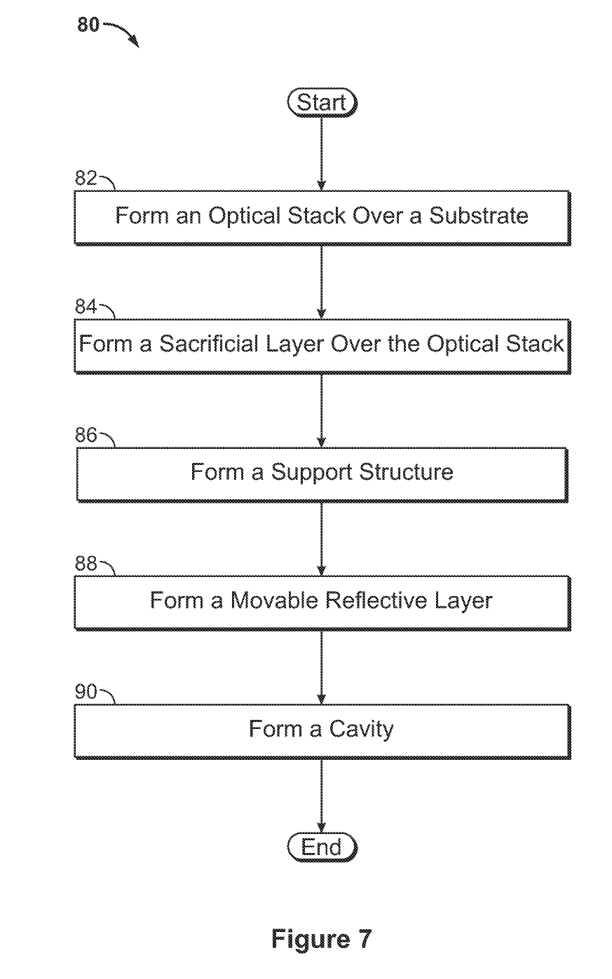

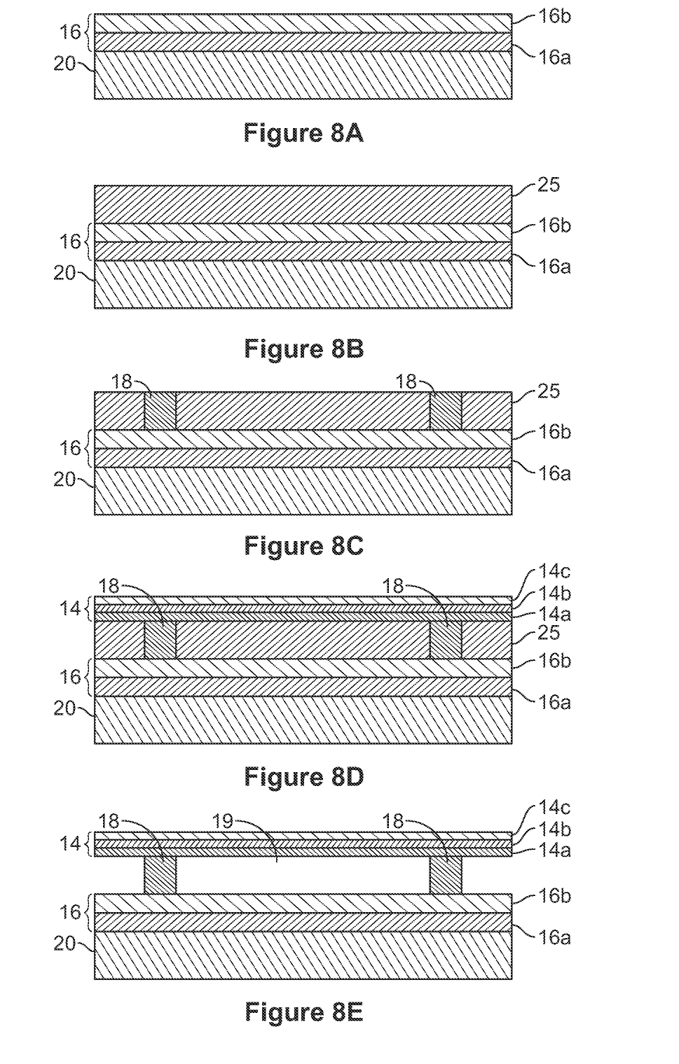

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (for example, one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the gap 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as gap 19 illustrated in FIGS. 1, 6 and 8E. The gap 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the gap 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Implementations of interferometric modulators described herein can operate in one or more states that are reflective and a state that is non-reflective in the visible range (non-reflective in the visible range can include, for example, dark or black). In certain implementations, each reflective state produces white light or light of a color determined by the distance between the reflective layer 14 and the optical stack 16 when the modulator 12 is in a reflective state. In other implementations, the reflective layer 14 may be positioned at a range of positions relative to the optical stack 16 to vary the size of the gap 19, and thus the color of the reflected light.

There generally is a tradeoff between choosing display elements that provide high brightness and choosing display elements that provide high color gamut (and/or color saturation) for the display. In both emissive and reflective displays, one approach to increase the color gamut may be to include additional color subpixels within each display pixel. However, by doing so, the brightness is actually compromised because the light-emitting area (or light-reflecting area in a reflective display) of each subpixel compared to the light-emitting/reflecting area of the total pixel is reduced in order to incorporate the additional subpixels within each pixel. Also, by adding additional subpixels that have a black state and a color state, more black states are incorporated into the pixel, and thus the brightness of each pixel may be compromised.

Certain implementations described herein can include a pixel that can produce additional colors without adding additional subpixels and without adding additional black states. For example, in certain implementations, each pixel can include a multi-state subpixel that can produce at least two colors, for example, a subpixel having a black state and two color states. In certain such implementations, because a single subpixel can produce at least two different colors, the light-emitting area of each color state compared to the light-emitting area of the total pixel is not reduced. Thus, examples of multi-state architectures are provided that can achieve both high reflectance and high color gamut. As an initial matter, certain aspects relating to colors and color models will be described.

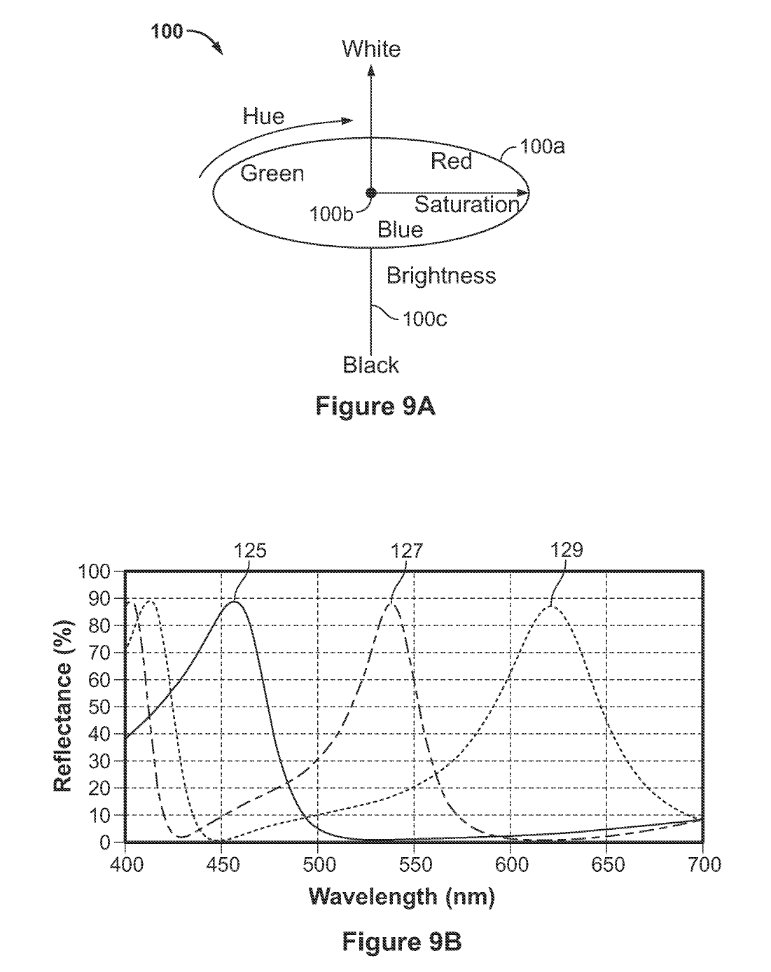

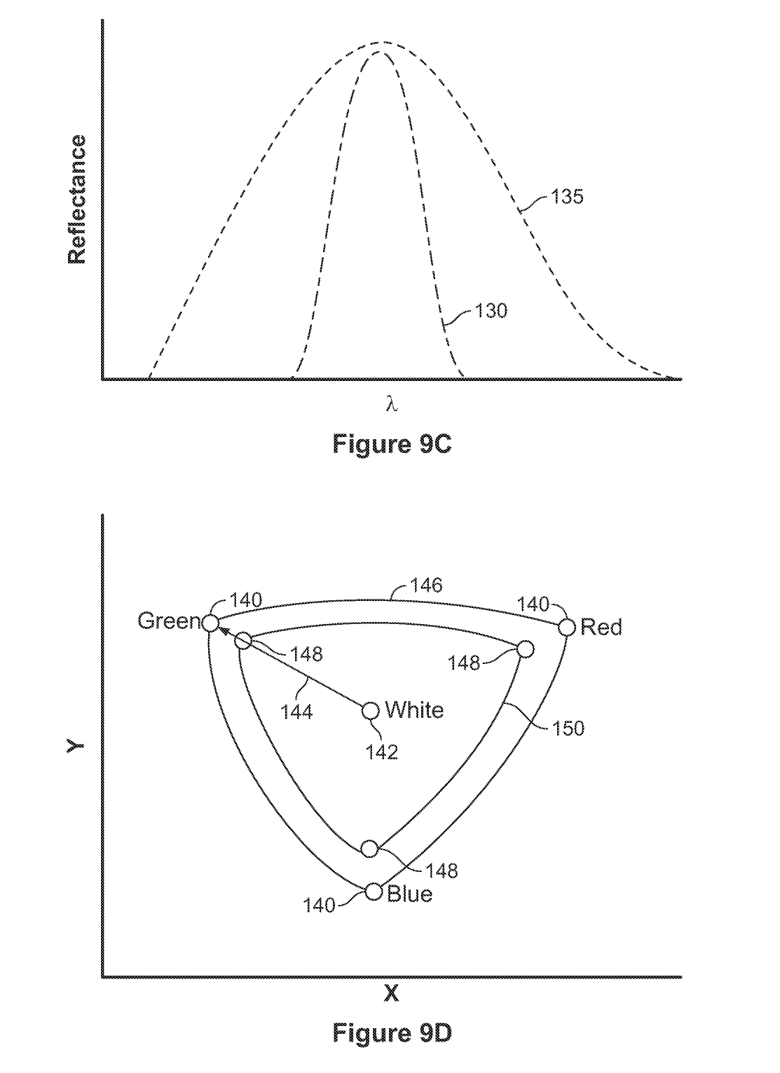

FIG. 9A shows an example color model. The color model can be used to illustrate an organization of ranges of colors. The example model can resemble a geometrical shape similar to a circle 100. Color may be represented in terms of one or more of the following: hue, chroma, saturation, value, brightness, lightness, luminance, correlated color temperature, dominant wavelength, or coordinate(s) in a color space (e.g., RGB or sRGB, CIE XYZ or CIELAB from the International Commission on Illumination, etc.).

In some cases, color as used herein can include hue, saturation, and brightness. For example, hue can be defined as the dominant wavelength of the perceived color (for example, the peak of a spectral reflectance associated with the hue). In FIG. 9A, different hues, e.g., red, green, and blue, can be disposed around the circle 100 with white located in the center 100b. A full color spectrum can be disposed around the circumference 100a of the circle 100. For example, hues not shown, for example, orange and yellow, can be disposed between the hues shown, for example, between red and green.

Saturation can be referred to as the dominance of hue in the color. A highly saturated hue can have a vivid, intense color, while a less saturated hue can appear more muted and grey. For example, a laser, which produces a very narrow range of wavelengths, produces highly saturated light. Conversely, a typical incandescent light bulb produces white light that may have a desaturated red or blue color. In FIG. 9A, the degree of saturation of the color can be indicated by the distance from the center 100b of the circle 100 to the position of the color on the circle 100. For example, more saturated colors are closer to the circumference 100a of the circle 100, while less saturated colors are closer to the center 100b.

Brightness can refer to the perceived amount of light. In FIG. 9A, brightness can form a shape in the third-dimension of the color circle 100, however, for simplicity in presentation, it is indicated by a vertical line 100c through the circle 100. For example, the bottom of the line 100c can represent black, while the top of the line 100c can represent the brightest white. The closer the color is to the top of the line 100c, the brighter the color.

FIG. 9B shows example spectral reflectances as a function of wavelength associated with three different hues. For example, spectral reflectances 125, 127 and 129 can be associated with a blue hue, a green hue, and a red hue respectively. For example the spectral reflectances 125, 127 and 129 have a range of wavelengths centered at about 455 nm, 545 nm, and 620 nm respectively. FIG. 9C shows example spectral reflectances as a function of wavelength for two different colors. Often, but not always, saturation can be related to the narrowness of the range of wavelengths of light output. For example, the color produced by curve 130 is more saturated than the color produced by curve 135. Brightness can be referred to as the perceived amount of light reflected by a display. In FIG. 9C, the color produced by curve 135 is brighter than the color produced by curve 130. For example, more light can be reflected by curve 135 because the area under the curve 135 is larger than the area under the curve 130. Thus, more saturated colors (for example, colors produced by display elements with a relatively narrow spectral reflectance similar to curve 130 relative to colors produced by display elements with a relatively broad spectral reflectance similar to curve 135) often tend to appear less bright than less saturated colors. Therefore, in general, there can be a tradeoff between saturation and brightness.

With reference to FIG. 1, the interferometric modulator 12 can include the (optical) gap 19 formed between the reflective layer 14 and the optical stack 16. The effective optical path length, L, of the gap 19 can determine the reflected wavelength, λ, of the overall interferometric modulator 12 structure. In certain implementations, the effective optical path length, L, can be substantially equal to the distance between the reflective layer 14 and the optical stack 16. In certain implementations, white light may be produced by having an effective optical path length, L, of less than about 100 Å (10 nm). The reflected wavelength, λ, of the interferometric modulator 12 generally can correspond to the perceived color of light reflected by the interferometric modulator 12, which in certain implementations can be described by Equation 1, where N is an integer.

$$L = \frac{1}{2} \cdot N \cdot λ \qquad ( Eqn . 1 )$$

A selected reflected wavelength, λ, thus can be reflected by interferometric modulators 12 having effective optical path lengths, L, of 0.5λ(N=1), λ(N=2), 1.5λ(N=3), etc. The integer N may be referred to as the “order” of interference of the reflected light. As used herein, the order of an interferometric modulator also may refer to the order N of light reflected by the interferometric modulator when the reflective layer 14 is in at least one position. For example, a first order (N=1) red interferometric modulator may have an effective optical path length, L, of about 325 nm, corresponding to a wavelength, λ, of about 650 nm. Accordingly, a second order (N=2) red interferometric modulator may have an effective optical path length, L, of about 650 nm. A list of examples of wavelength ranges for some common colors used in interferometric modulator displays are shown in Table 1. Although the wavelength ranges shown in Table 1 are listed with eight common colors, the wavelengths within these ranges may actually be a non-traditional color, for example, purplish-blue light at around 470-490 nm and greenish-yellow light at around 570-600 nm. In addition, an interferometric modulator may also reflect light having a significant contribution from a relatively broad range of wavelengths, for example, magenta light which can be a combination of red and blue light.

TABLE 1

| Color | Wavelength (nm) |
|---|---|
| Violet | 380-420 |
| Indigo | 420-440 |
| Blue | 440-500 |
| Cyan | 500-520 |
| Green | 520-565 |
| Yellow | 565-590 |
| Orange | 590-625 |
| Red | 625-740 |

When the gap 19 includes a material, such as a fluid, having an index of refraction of approximately 1 (for example, air), the effective optical path length, L, can be substantially equal to the distance between the reflective layer 14 and the optical stack 16. When the gap 19 includes a material having an index of refraction of greater than 1, the effective optical path length, L, may be different from the distance between the reflective layer 14 and the optical stack 16. In implementations in which the optical stack 16 includes an insulating layer, the effective optical path length, L, can be affected by the thickness and index of refraction of the insulating layer such that the effective optical path length, L, can be different from the distance between the reflective layer 14 and the optical stack 16. In certain implementations, the distance between the reflective layer 14 and the optical stack 16 can be selected to compensate for the material in the gap 19 and/or an insulating layer in the optical stack 16 by modifying the thickness of a sacrificial material disposed between the reflective layer 14 and the optical stack 16 during fabrication of the interferometric modulator 12.

In designing a display using interferometric modulators 12, the modulators 12 may be formed so as to increase the color saturation of reflected light. In one implementation, the modulator 12 can be formed with a distance L corresponding to higher order of interference, for example, 2nd or 3rd order, to increase the saturation of reflected color light. Generally, higher order modulators reflect light over a narrower range of wavelengths, and thus can produce colored light that is more saturated. Higher order modulators generally utilize larger distances between the reflective layer 14 and the optical stack 16. Additionally, because higher order modulators can reflect a narrower range of wavelengths, the number of photons that can be reflected is reduced and the display can appear less bright.

An example additive color display can include a combination of display elements, e.g., red, green, and blue interferometric modulators 12 as described herein. Other colors can be produced in such a display by varying the relative spectral reflectance of light produced by the red, green, and blue interferometric modulators 12. Such mixtures of primary colors such as red, green, and blue can be perceived by the human eye as other colors. The relative values of red, green, and blue in such a color system may be referred to as tristimulus values in reference to the stimulation of red, green, and blue light sensitive portions of the human eye. In other implementations, the display may include display elements having sets of colors that define other color systems in terms of sets of primary colors other than red, green, and blue, for example, as will be discussed further below.

FIG. 9D is an example chromaticity diagram that illustrates examples of colors that can be produced by a color display that includes red, green, and blue display elements. The horizontal and vertical axes (X, Y) can define a chromaticity coordinate system on which a projection of spectral tristimulus values may be depicted. In particular, the vertices or points 140 can illustrate the color of light reflected by red, green, and blue display elements.

White light can be indicated by a point 142. The white light produced by a display may be characterized by the white point of the display. The white point of a display is the hue that can be considered to be generally neutral (gray or achromatic). The white point of a display may be characterized based on a comparison of white light produced by the display with the spectral content of light emitted by a black body at a particular temperature (“black body radiation”). A black body radiator is an idealized object that can absorb all light incident upon the object and which can reemit the light with a spectrum dependent on the temperature of the black body. For example, the black body spectrum at 6,500 K may be referred to as white light having a color temperature of 6,500 K. Such color temperatures, or white points of approximately 5,000-10,000 K are generally identified with daylight.

The International Commission on Illumination (CIE) promulgates standardized white points of light sources. For example, light source designations of “D” refer to daylight. In particular, standard white points D₅₅, D₆₅, and D₇₅, which correlate with color temperatures of 5,500 K, 6,500 K, and 7,500 K, are standard daylight white points.

A display device may be characterized by the white point of the white light produced by a display. As with light from other light sources, human perception of a display can be at least partially determined by the perception of white light from the display. For example, a display or light source having a lower white point, such as D₅₅, may be perceived as having a yellow tone by a viewer. A display having a higher temperature white point, such as D₇₅ may be perceived as having a “cooler” or bluer tone to a viewer. Some users respond more favorably to displays having higher temperature white points, while other users respond more favorably to displays having lower temperature white points. Thus, controlling the white point of a display can provide some control over a viewer's response to a display.

The distance from the point 142 of white light to each point 140, for example, the distance 144 between the point 142 for white and the point 140 for green light, can be indicative of the saturation of light produced by the corresponding display element. The region enclosed by the triangular trace 146 can correspond to the range of colors that can be produced by mixing the light produced at vertices or points 140. This range of colors may be referred to as the color gamut of the display. Thus, in some cases, the color gamut may be quantified by the area of the trace 146. In some other cases, the color gamut may be compared to the color gamut generated by the Society of Motion Picture and Television Engineers (SMPTE), by the European Broadcast Union (EBU) red, green, and blue phosphors, or to the color gamut generated by an RGB color space such as sRGB. For example, the comparison may be quantified as a ratio of the area of the triangular trace 146 and the area of the triangular trace formed by a standard color gamut (e.g., EBU red, green, and blue phosphors). In some implementations, two color gamuts can be compared by comparing their respective areas (for example, the respective areas of the trace 146). For example, a first color gamut may be larger than a second color gamut, because the area of the first color gamut is larger than the area of the second color gamut.

For example, points 148 can indicate the spectral response of another set of display elements. Since the distance between the white point 142 and the point 148 is smaller than between point 142 and points 140, the display elements corresponding to the points 148 can produce less saturated color than do the display elements corresponding to the points 140. The trace 150 can indicate the range of colors that can be produced by mixing the light of points 148. As is shown in FIG. 9D, the trace 146 can enclose a larger area than can the trace 150, graphically illustrating the relationship between the saturation of the display elements and the size of the color gamut of the display. Thus, in some cases, the more saturated the display elements, the larger the size of the color gamut of the display.

For some implementations, the brightness of the white light output by the display can decrease with increasing color gamut of the display (and/or with increasing saturation of the display elements). For example, in some implementations, a larger color gamut can be formed by more saturated colors. Because the total amount of light reflected by combining three highly-saturated colors to form white can be less than the total amount of light reflected by combining three less-saturated colors to form white, the white light output can appear less bright. For example, combining three relatively broader spectral reflectance curves (such as curve 135 of FIG. 9C) can produce a brighter white than combining three relatively narrower spectral reflectance curves (such as curve 130 of FIG. 9C). Thus, to increase the brightness of the white light, the color gamut of the display can be reduced (such as trace 150 rather than trace 146) and/or less saturated primary colors may be chosen (such as the colors 148 rather than the more saturated colors 140). Accordingly, there generally is a tradeoff between additive display brightness and color gamut (and/or saturation).

Certain implementations of a display device that can simultaneously increase both the brightness and the color gamut (and/or saturation) of the display are disclosed herein. For example, the display device can include a plurality of pixels, such as reflective pixels. Each pixel further can include a plurality of subpixels where each subpixel can be configured to be selectively switched among a first state, a second state, and a third state. The three states of each of the subpixels may produce, for example, black and two different colors. In other implementations, the three states may produce black, white, and a color, white and two different colors, or three different colors. The states of the subpixels can be selected such that each subpixel can have a spectral reflectance associated with a color in a first set of primary colors. The first set of primary colors may be chosen so that the display device can produce a high brightness. The states of the subpixels can also be selected such that each subpixel can have a spectral reflectance associated with a color in a second set of primary colors. The second set of primary colors may be chosen so that the display device can produce a high color gamut (and/or saturation). By having a pixel that includes two sets of primary colors within a single pixel, certain implementations can provide a display device that produces a display with both a higher brightness (for example, higher reflectance) and larger color gamut (and/or saturation) than a display device having only one of the two sets of primary colors. This can be done in some implementations, for example, where the first set of primary colors includes complementary colors that combine to produce white and the combination of the first set of primary colors has a brightness that is higher than a brightness of a combination of the second set of primary colors. The second set of primary colors are selected so that the gamut of the display overall is greater than the gamut of the display based upon the first set of primary colors alone.

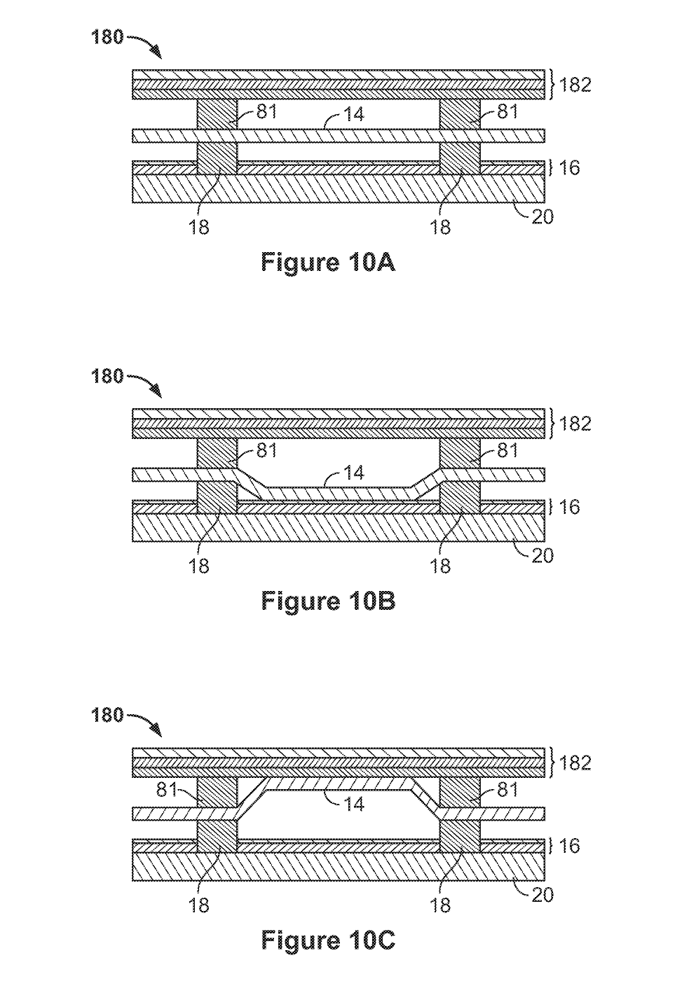

An example subpixel can include an interferometric modulator that can be selectively switched among a first state, a second state, and a third state. FIGS. 10A-10C show schematic side cross-sectional views of an example multi-state interferometric modulator. The interferometric modulator 180 can allow decoupling of display brightness and color gamut so that reflective displays having large color gamut can be provided. For example, by being able to selectively switch to three different states, the additional colors can be provided without incorporating additional black states and without reducing the area of reflectance of the subpixel as compared with the area of reflectance of the total pixel. As shown in FIGS. 10A-10C, the example modulator 180 includes a movable reflective layer 14 that is positioned between an electrode in the optical stack 16 and an electrode in a bus stack 182, and is movable between a first state, a second state, and a third state. Other configurations of multi-state interferometric modulators are also compatible with certain implementations described herein.

In the example modulator 180 of FIGS. 10A-10C, the bus stack 182 may be formed on posts 81 that are formed on the side of the reflective layer 14 opposite the posts 18. The bus stack 182, as referenced herein, typically includes several fused layers, which can include a conductive electrode layer, such as aluminum, and an insulating dielectric layer. In certain implementations, the bus stack 182 includes an insulating layer between the reflective layer 14 and the electrode in the bus stack 182 in order to prevent electrical shorts between conductive portions of the reflective layer 14 and the electrode in the bus stack 182. The bus stack 182 may be fabricated, for example, by depositing one or more of the above layers over a sacrificial layer formed on top of the reflective layer 14.

The modulator 180 can produce a first spectral reflectance in a first state, a second spectral reflectance in a second state, and a third spectral reflectance in a third state. FIG. 10A illustrates the modulator 180 in a relaxed position with the reflective layer 14 between the optical stack 16 and the bus stack 182. The relaxed position may be considered as the first, second, or third state. FIG. 10B illustrates the modulator 180 in an actuated (or “driven”) position with the reflective layer 14 proximate to the optical stack 16. The actuated position may be considered as the first, second, or third state. FIG. 10C illustrates the modulator 180 in a reverse-actuated (or “reverse driven”) position with the reflective layer 14 proximate to the bus stack 182. The reverse-actuated position may be considered as the first, second, or third state. In other words, any of the relaxed, actuated, or reverse-actuated states (illustrated in FIGS. 10A, 10B, and 10C) can be the first state; another of the relaxed, actuated, or reverse-actuated states (illustrated in FIGS. 10A, 10B, and 10C) can be the second state; and a remaining state of the relaxed, actuated, or reverse-actuated states (illustrated in FIGS. 10A, 10B, and 10C) can be the third state. The interferometric modulator 180 can produce an actuated spectral reflectance in the actuated position, a relaxed spectral reflectance in the relaxed position, and a reverse-actuated spectral reflectance in the reverse-actuated position. The distances from the reflective layer 14 to the partially reflective layer in the optical stack 16 in each of the relaxed position, the actuated position, and the reverse-actuated position, among other things—such as the material in the gap 19 between the reflective layer 14 and the optical stack 16, and properties of an insulating layer in the optical stack 16—can influence the spectral reflectances of the modulator 180 in those positions.

The reverse-actuated position of FIG. 10C can be achieved in a number of ways. In one implementation, the reverse-actuated position can be achieved through the use of an electrode or conductive layer in the bus stack 182 that can electrostatically pull the reflective layer 14 in the upward direction. In such an implementation, the modulator 180 basically can be considered similar to two interferometric modulators positioned symmetrically around a single movable reflective layer 14. In some implementations, a different voltage can be applied to the optical stack 16, the reflective layer 14, and the bus stack 182. In various implementations, the electrodes of the optical stack 16 and the bus stack 182 can electrostatically pull the reflective layer 14 in opposite directions, or, alternatively, in the same direction.

The materials used to produce the layers of the bus stack 182 can be dissimilar to the materials used to produce the optical stack 16. For example, the bus stack 182 may not transmit light. Additionally, if the conductive layer of the bus stack 182 is positioned beyond the reach of the reflective layer 14 in its deformed upward position, then the modulator 180 may or may not include an insulating layer between the reflective layer 14 and the conductive layer in the bus stack 182.

The voltages applied to the optical stack 16 to drive the reflective layer 14 from the relaxed position of FIG. 10A to the actuated position of FIG. 10B may be different from the voltage applied to the optical stack 16 to drive the reflective layer 14 from the reverse-actuated position of FIG. 10C to the actuated position of FIG. 10B. The voltages applied to the bus stack 182 to drive the reflective layer 14 from the relaxed position of FIG. 10A to the reverse-actuated position of FIG. 10C may be different from the voltage applied to the bus stack 182 to drive the reflective layer 14 from the actuated position of FIG. 10B to the reverse-actuated position of FIG. 10C. The voltages applied to the bus stack 182 to drive the reflective layer 14 from the relaxed position of FIG. 10A or the actuated position of FIG. 10B to the reverse-actuated position of FIG. 10C may or may not be the same as the voltages applied to the optical stack 16 to drive the reflective layer 14 from the relaxed position of FIG. 10A or the reverse-actuated position of FIG. 10C to the actuated position of FIG. 10B. Furthermore, the voltage applied to the optical stack 16 to drive the reflective layer 14 from the relaxed position of FIG. 10A to the actuated position of FIG. 10B may be the same or different from the voltage applied to the bus stack 182 to drive the reflective layer 14 from the relaxed position of FIG. 10A to the reverse-actuated position of FIG. 10C. Also, the voltage applied to the bus stack 182 to drive the reflective layer 14 from the actuated position of FIG. 10B to the reverse-actuated position of FIG. 10C may be the same or different from the voltage applied to the optical stack 16 to drive the reflective layer 14 from the reverse-actuated position of FIG. 10C to the actuated position of FIG. 10B. Such voltages can depend upon the desired application and amounts of deflection.

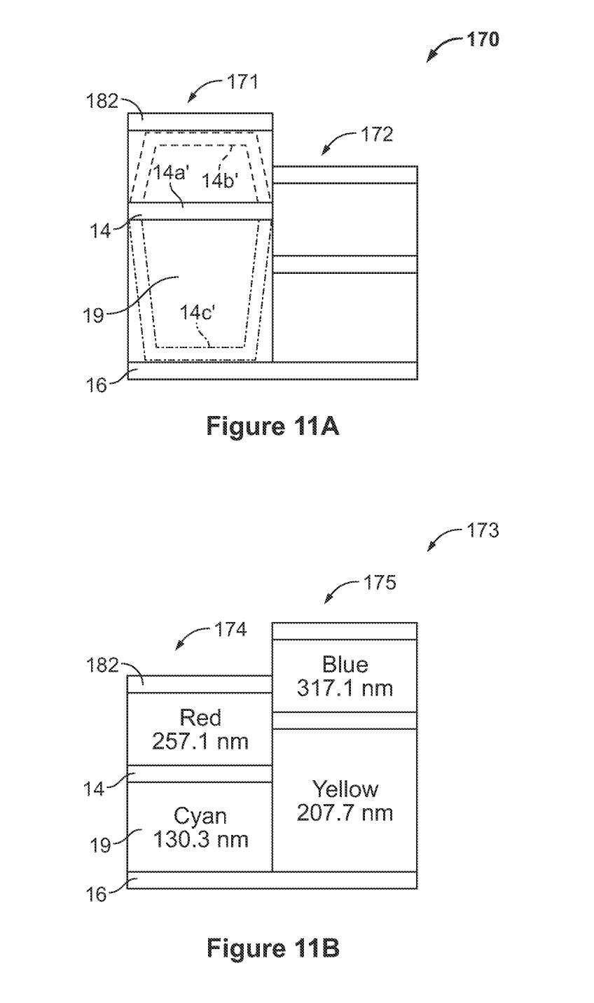

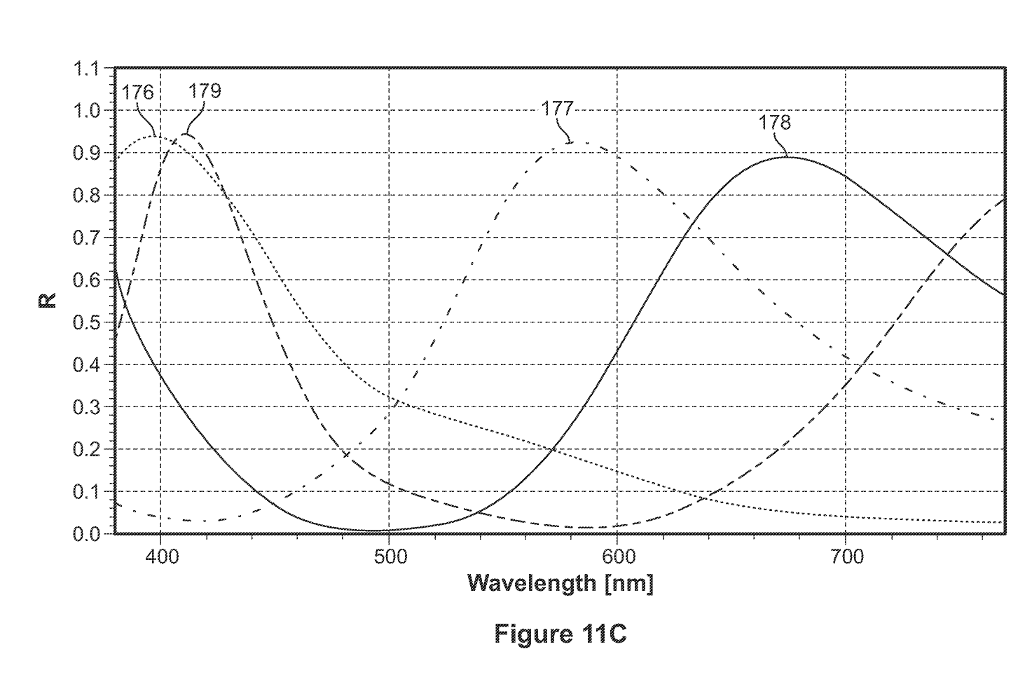

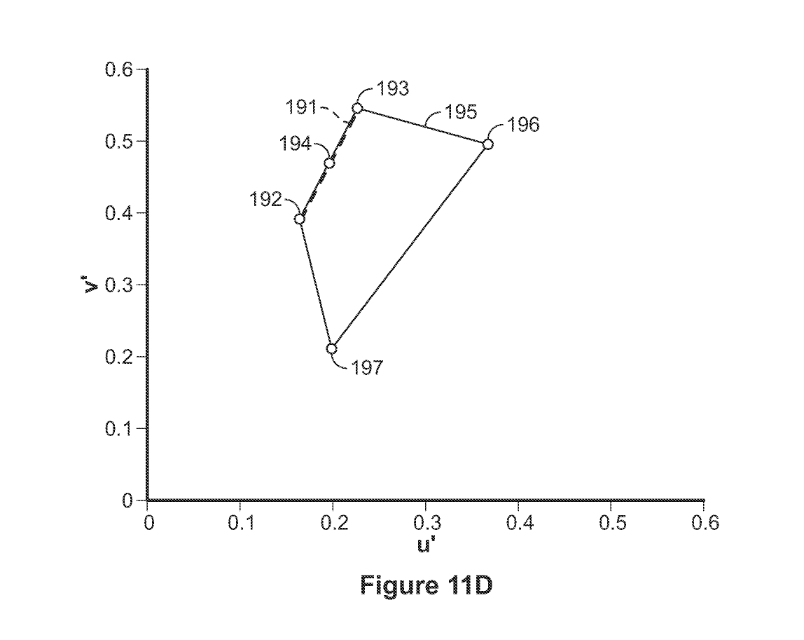

FIG. 11A schematically illustrates a side cross-sectional view of an example pixel including a plurality of subpixels. The number of subpixels in a pixel can be two, three, four, five, six, or more. For example, FIG. 11A shows a pixel having two subpixels 171 and 172. Each subpixel can include an interferometric modulator 180 such as the example shown in FIGS. 10A-10C. For example, each subpixel 171 and 172 can include a movable reflective layer 14 (illustrated as 14a′, 14b′ and 14c′ to indicate various possible positions for the movable reflective layer 14), an optical stack 16, and a bus stack 182. Each subpixel 171 and 172 can be configured to be selectively switched among a first state, a second state, and a third state. The movable reflective layer 14 can be located in a different position in each of the three states. For example, the movable reflective layer 14 is shown in solid/dashed/dot-dashed lines in subpixel 171 to indicate that the movable reflective layer 14 can be in one of three positions—a relaxed position 14a′, an actuated position 14c′, and a reverse-actuated position 14b′.

For example, if the first state corresponds to the relaxed position 14a′, the reflective layer 14 of subpixel 171 can be positioned between the optical stack 16 and the bus stack 182, such that the first state can have an associated relaxed spectral reflectance. If the second state corresponds to the reverse-actuated position 14b′, the reflective layer 14 of subpixel 171 can move proximate to the bus stack 182 resulting in a distance between the reflective layer 14 and the optical stack 16 such that the second state can have an associated reverse-actuated spectral reflectance. If the third state corresponds to the actuated position 14c′, the reflective layer 14 of the subpixel 210 can move proximate to the optical stack 16 such that the third state can have an associated actuated spectral reflectance. Each state of subpixel 171 can have a different spectral reflectance from each of the other states. For example, each state can be associated with a spectral reflectance associated with a (non-white or non-black) color, a white color, or a black color. For example, the relaxed spectral reflectance can be associated with a (non-white or non-black) color, a white color, or a black color. The reverse-actuated spectral reflectance can be associated with a (non-white or non-black) color, a white color, or a black color. The actuated spectral reflectance can be associated with a (non-white or non-black) color, a white color, or a black color. Thus, various implementations of a subpixel can produce, for example, black color and two different colors; white color and two different colors; black color, white color, and a third color; or three different (non-white or non-black) colors.

Similar to subpixel 171, for subpixel 172, the first state can correspond to the relaxed position, the second state can correspond to the reverse-actuated position, and the third position can correspond to the actuated position. Thus, subpixel 172 can have a first state associated with a relaxed spectral reflectance, a second state associated with a reverse-actuated spectral reflectance, and a third state associated with an actuated spectral reflectance. In some implementations, subpixel 171 and subpixel 172 may have the first state corresponding to different positions from each other. As one example, for subpixel 172, the first state may correspond to the reverse-actuated position (instead of the relaxed position), the second state may correspond to the relaxed position (instead of the reverse-actuated position), and the third position may correspond to the actuated position.

In certain implementations, at least one state of subpixel 171 (e.g., the first state and/or the second state and/or the third state) and at least one state of subpixel 172 (e.g., the first state and/or the second state and/or the third state) can have spectral reflectances associated with a first set of primary colors. At least one state of subpixel 171 (e.g., the first state and/or the second state and/or the third state) and at least one state of subpixel 172 (e.g., the first state and/or the second state and/or the third state) can have spectral reflectances associated with a second set of primary colors. For example, the first state of subpixel 171 and the first state of subpixel 172 can have spectral reflectances associated with a first set of primary colors. In addition, the second state of subpixel 171 and the second state of subpixel 172 can have spectral reflectances associated with a second set of primary colors. As another example, the first state of subpixel 171 and the second state of subpixel 172 can have spectral reflectances associated with a first set of primary colors. Also, the second state of subpixel 171 and the first state of subpixel 172 can have spectral reflectances associated with a second set of primary colors. As a third example, the first state of subpixel 171 and the second and third states of subpixel 172 can have spectral reflectances associated with a first set of primary colors. The second and third states of subpixel 171 and the first state of subpixel 172 can have spectral reflectances associated with a second set of primary colors. Other examples of combinations are possible.

As used herein, a pixel can generally be considered as the smallest unit of a display capable of displaying the entire color gamut that can be produced by the display. The subpixels of a pixel can represent a portion of the pixel that is configured to display a a particular color or colors in the gamut of the display color space. Each of the subpixels in a pixel may, but need not be, separately addressable. For example, each subpixel can define a vertex of the color gamut of the display (see, for example, FIG. 9D). For a pixel to produce a desired color within the color gamut of the display, one or more subpixels can be selectively switched so that the combined light from the subpixels produces the desired color. Primary colors, as used herein, can be the set of colors produced by the subpixels of the pixel. Since in certain implementations, the pixel can display a first set of primary colors and a second set of primary colors, the first and/or second sets of primary colors can be combined to provide the color gamut of the display.

The first set of primary colors can be different from the second set of primary colors. In some implementations, only one of the colors in the second set of primary colors may be different from the first set of primary colors, while in other implementations, more than one of the colors in the second set of primary colors may be different from the first set of primary colors. As described herein, in some implementations, color can be represented by hue, saturation, and brightness. Thus, a color can be considered different from another color based on a difference in at least one of hue, saturation, and/or brightness. For example, a more saturated green can be considered as a different color from a less saturated green, even though the hue of both colors is the same. In addition, in certain implementations, two subpixels (or first, second, or third states of different subpixels) designed to have the same color but are slightly different due to manufacturing variations may not be considered as different colors solely due to the manufacturing variation.

In certain implementations, the first set of primary colors (such as two or more colors) can include colors that can combine to produce white. As one example, the first set of primary colors can include red (R), green (G), and blue (B). As another example, the first set of primary colors can include complementary colors, such as green and magenta, that can combine to produce white. Complementary colors, as used herein, can include colors that can combine to produce white, and not necessarily limited to only colors that are opposite each other on a color model. For example, the first set of primary colors may include cyan and yellow that can combine to produce white. In some implementations, the first set of primary colors can combine to produce a standardized white point, for example one of D₅₅, D₆₅, or D₇₅.

In certain implementations, the combination of colors of the first set of primary colors can have a brightness that is higher than a brightness of a combination of colors of the second set of primary colors. Thus, certain implementations of a display device can have a plurality of pixels 170 as the one shown and described in reference to FIG. 11A. The subpixels of one or more pixels 170 can be selectively switched to output the first set of primary colors together to output white. The white produced using the first set of primary colors can have a higher brightness than a white produced using the second set of primary colors. In addition, use of white in combination with color may increase the brightness of the pixels than without the use of white in combination with a color. For example, a color produced with some of the subpixels using the second set of primary colors combined with some of the subpixels using the first set of primary colors may appear brighter than a similar color produced with the subpixels using the second set of primary colors alone. As another example, a less bright green used in combination with a different, brighter color may in some cases appear brighter than the green alone. Thus, one or more other pixels within the plurality of pixels can be selectively switched to output a color using a combination of colors of the second set of primary colors. By using one or more pixels to output a bright color using the colors from the first set of primary colors in combination with one or more other pixels outputting a color using a combination of colors of the second set of primary colors, the display device can provide a display with increased brightness over a display device having pixels with only the second set of primary colors.

In addition, in some implementations, the second set of primary colors can be selected to increase the color gamut of the display device as compared to a display device having only subpixels associated with the first set of primary colors. For example, the colors of the first set of primary colors can form a first color gamut and the colors of the second set of primary colors can contribute to form a total color gamut. In some implementations, the second set of primary colors can form a second color gamut that can be larger than the first color gamut. In other implementations, the second color gamut may be smaller than the first color gamut, yet the total color gamut can be larger than the first color gamut. In some implementations, the second color gamut may not overlap (or may only partially overlap) the first color gamut and may form a total color gamut that can be larger than the first color gamut. In some implementations, when projected on a two-dimensional color chromaticity diagram (such as the one shown in FIG. 9D), the first color gamut can lie within the second color gamut. In some other implementations, at least one color of the first color gamut can lie outside the second color gamut yet the first color gamut can still be smaller than the second color gamut. In some implementations, the first color gamut can be rotated at a non-zero angle relative to the second color gamut. In some implementations, one or more of the hues of the first primary colors in the first gamut are different from the hues of the second primary colors in the second gamut.

In the example implementation described above, a display device can use one or more pixels to output a relatively brighter white color compared to when the pixels are selectively switched to output white color using colors in the second set of primary colors. In addition, at least one subpixel of one or more pixels can be selectively switched to output a color using the second set of primary colors to produce a color outside the first color gamut. Thus, certain implementations of the display device can simultaneously increase both the brightness and the color gamut of a display when compared to a display device using only one set of primary colors. In some implementations, the brightness, for example, the measured or simulated/modeled reflectance of the white light, can be increased up to at least about 20% higher, up to at least 25% higher, up to at least 30% higher, up to at least 35% higher, or up to at least about 40% higher than pixels including bi-stable (two color) interferometric modulator pixels. Also, the color gamut, such as determined as the area when compared to a standard color gamut or to a color gamut of another display device, can be increased up to at least about 50% higher, up to at least about 55% higher, up to at least about 60% higher, up to at least about 65% higher, up to at least about 70% higher, or up to at least about 75% higher than pixels including bi-stable (two color) interferometric modulator pixels.

Since the display's color gamut in general can increase with display elements having relatively higher saturation, certain implementations not only simultaneously increase the brightness and color gamut of the display as compared to a display device using only one set of primary colors, but also can increase color saturation of some of the colors achievable by the display. For example, as described above, a display device can use at least one pixel to output a relatively brighter white compared to when the pixel is selectively switched to output white light using colors in the second set of primary colors. In addition, since using white in combination with color can in some cases increase the brightness, at least one subpixel of another pixel can be selectively switched to output a color outside the first color gamut. In some implementations, the color outside the first color gamut can have a higher color saturation than when the subpixels of the pixel are selectively switched to use a combination of colors of the first primary colors to output a similar hue. Thus, certain implementations of the display device can simultaneously increase both the color saturation and the brightness of the display compared to a display device using only one set of primary colors.

In certain implementations, the second set of primary colors can also be selected in order to increase saturation of the display device as compared to a display device having only subpixels associated with the first set of primary colors. For example, in certain implementations, the colors of the second set of primary colors can be colors with relatively higher saturation than the colors of the first set of primary colors. In some implementations, at least one color of the second set of primary colors may include a higher order color, such as a second order color, to increase saturation of the display device.

FIG. 11B schematically illustrates a side cross-sectional view of an example pixel as shown in FIG. 11A. As shown in FIG. 11B, pixel 173 can include subpixel 174 that can have a first state (for example, a relaxed position) associated with a spectral reflectance associated with a cyan color (for example, having a distance between the reflective layer 14 and the optical stack 16 of about 130.3 nm). Subpixel 174 also can have a second state (for example, a reverse-actuated position) associated with a spectral reflectance associated with a red color (for example, having a distance between the reflective layer 14 and the optical stack 16 of about 257.1 nm). As shown in FIG. 11B, pixel 173 also can include subpixel 175 that can have a first state (for example, a relaxed position) associated with a spectral reflectance associated with a yellow color (for example, having a distance between the reflective layer 14 and the optical stack 16 of about 207.7 nm). Subpixel 175 also can have a second state (for example, a reverse-actuated position) associated with a spectral reflectance associated with a blue color (for example, having a distance between the reflective layer 14 and the optical stack 16 of about 317.1 nm). In this example, the third state (for example, an actuated position) for each of the subpixels 174 and 175 can be associated with a spectral reflectance of a black color.

Each subpixel 174 and 175 (for example, in a first state) can have a spectral reflectance associated with a first set of primary colors. For example, the first set of primary colors can include cyan and yellow. Also, each subpixel 174 and 175 (for example, in a second state) can have a spectral reflectance associated with a second set of primary colors. For example, the second set of primary colors can include red and blue.

In order to form the gaps above and below the movable reflective layer 14 in the relaxed position (see FIG. 10A), a first sacrificial layer can be deposited, followed by the movable reflective layer 14 (which can include multiple sub-layers), followed by a second sacrificial layer. As can be seen from FIG. 11B, forming subpixel 174 can include depositing a first sacrificial layer of about 130 nm, depositing the movable reflective layer 14, and depositing a second sacrificial layer of about 127 nm. Similarly, forming subpixel 175 can include depositing a first sacrificial layer of about 208 nm, depositing the movable reflective layer 14, and depositing a second sacrificial layer of about 109 nm. Bus stack 182 can be deposited after the second sacrificial layer. The first sacrificial layers can be deposited using two masks, and the second sacrificial layers can also be deposited using two masks. Since the first and second sacrificial layers of subpixel 174 and the first and second sacrificial layers of subpixel 175 each have different thicknesses, in some implementations a total of four masks can be used to deposit all of the sacrificial layers in the pixel design illustrated in FIG. 11B.

FIG. 11C shows the spectral reflectances as a function of wavelength for the example pixel shown in FIG. 11B. For example, spectral reflectances 176 and 177 can be associated with the first set of primary colors of cyan and yellow respectively. Likewise, spectral reflectances 178 and 179 can be associated with the second set of primary colors of red and blue respectively. The first set of primary colors can combine to produce white light. For example, as shown in FIG. 11C, curves 176 and 177 can combine to form a spectral response having relatively high reflectivity over a broad range of wavelengths over the visible range to appear as white light. In addition, a combination of colors of the first set of primary colors can have a brightness that is higher than a brightness of a combination of colors of the second set of primary colors. Thus, in certain implementations of a display device having a plurality of pixels 173 similar to the one shown and described in reference to FIG. 11B, the subpixels of at least one of the plurality of pixels 173 can be selectively switched to output a relatively brighter white (for example, in the first state) compared to when selectively switched to produce white light using colors in the second set of primary colors (for example, in the second state).

FIG. 11D shows the chromaticity diagram that illustrates the colors that can be produced by the example pixel shown in FIG. 11B. Trace 191 can correspond to the range of colors that can be produced by the first set of primary colors corresponding to points 192 (cyan) and 193 (yellow). The first set of primary colors can produce the colors on the trace 191, for example, the line connecting points 192 and 193. As shown in FIG. 11D, the first set of primary colors can combine to produce white light, for example, represented by point 194 lying on trace 191. Trace 195 can correspond to the range of colors that can be produced by the pixel 173 by incorporating the second set of primary colors corresponding to points 196 (red) and 197 (blue). For example, trace 195 can correspond to the convex hull produced by points 192 (cyan), 193 (yellow), 196 (red), and 197 (blue).

Certain implementations of the display device using pixels as shown in FIGS. 11B-11D can simultaneously increase both the brightness and the color gamut of a display as compared to a display device using only one set of primary colors. For example, a display device can use at least one of a plurality of these pixels to output a relatively brighter white (or a color) compared to when the pixel is selectively switched to output white light (or light having a color) using colors in the second set of primary colors. As shown in FIG. 11D, the first set of primary colors, for example, points 192 (cyan) and 193 (yellow), lies closer to point 194 (white) than the second set of primary colors, for example, points 196 (red) and 197 (blue). In addition, one or more subpixels of another one of these such pixels can be selectively switched to output a color outside the first color gamut (for example, in the second state to produce a color within trace 195 as opposed to only along trace 191).

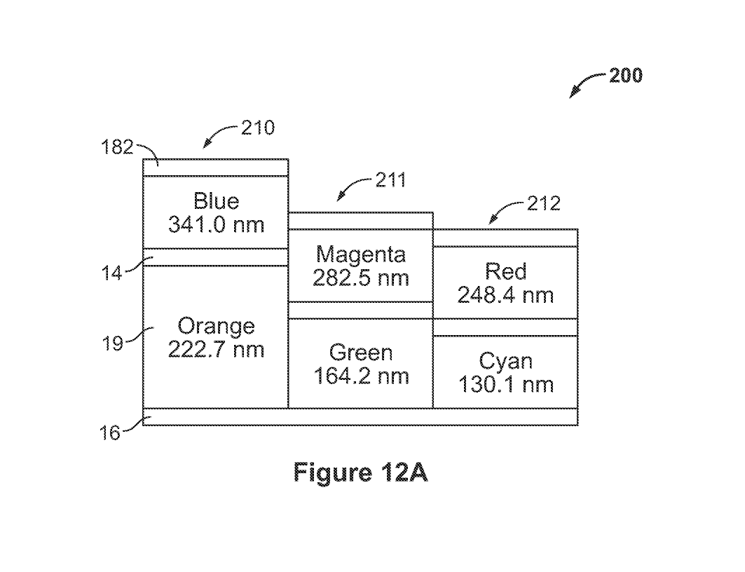

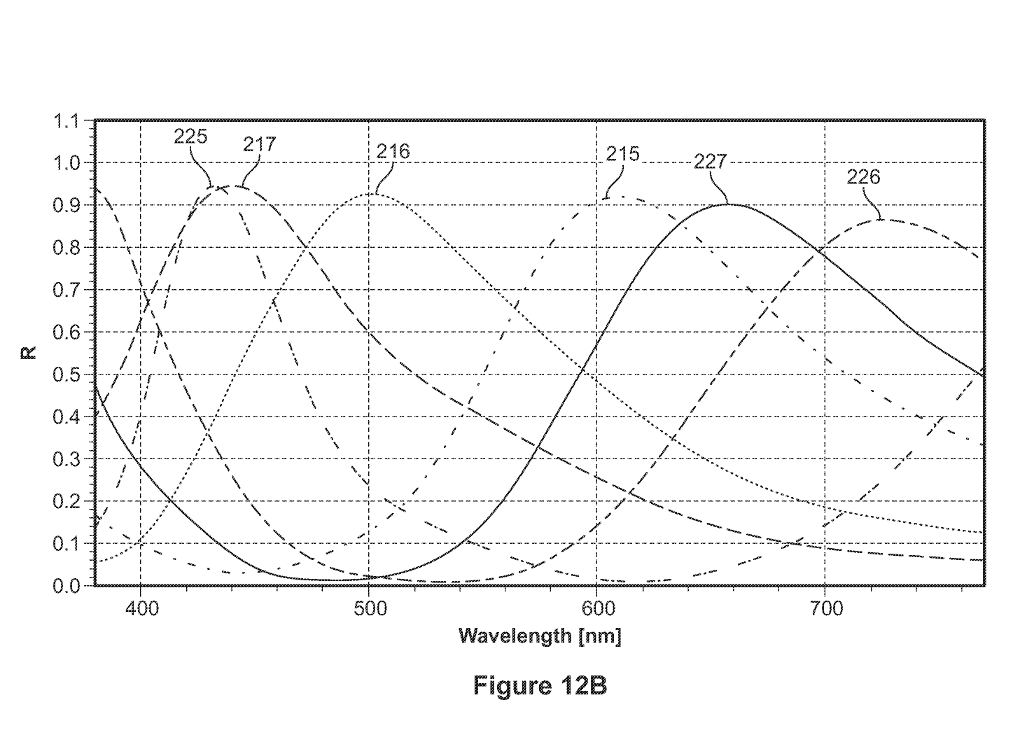

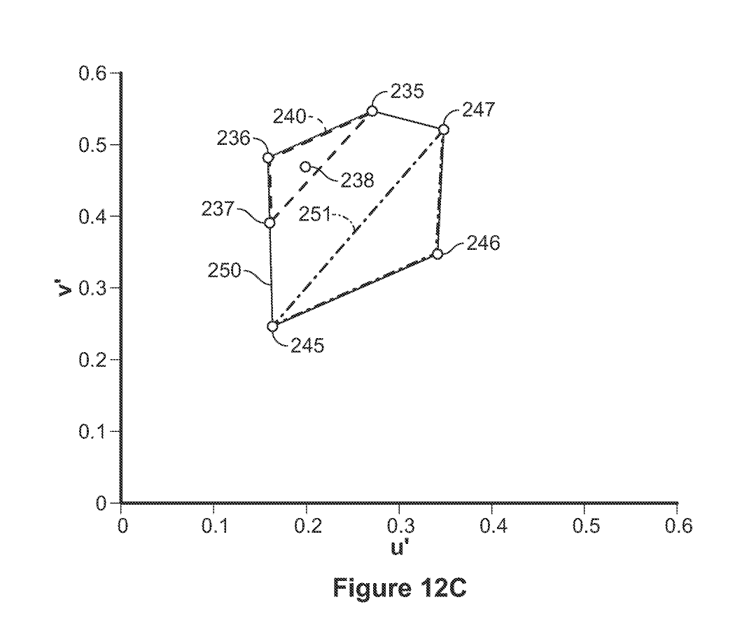

FIG. 12A schematically illustrates a side cross-sectional view of an example pixel. As shown in FIG. 12A, each pixel 200 can include a plurality of subpixels, for example, at least three subpixels 210, 211 and 212. Each subpixel can include an interferometric modulator 180 such as the example shown in FIGS. 10A-10C. If the first state corresponds to the relaxed position, subpixel 210 can have a first state associated with a spectral reflectance associated with an orange color. As shown in FIG. 12A, subpixel 210 can have a distance between the reflective layer 14 and the optical stack 16 of about 222.7 nm. As described herein, the distance between the reflective layer 14 and the optical stack 16 may be different from the effective optical path length, L, for example, to compensate for material in the gap 19 and/or an insulating layer in the optical stack 16.

If the second state corresponds to the reverse-actuated position, subpixel 210 can have a second state associated with a spectral reflectance associated with a blue color. For the reverse-actuated position in this example, the reflective layer 14 can move proximate to the bus stack 182 resulting in a distance between the reflective layer 14 and the optical stack 16 of about 341.0 nm. Again, the distance between the reflective layer 14 and the optical stack 16 may be different from the effective optical path length, L, for example, to compensate for material in the gap 19 and/or an insulating layer in the optical stack 16. If the third state corresponds to the actuated position, subpixel 210 can have a third state associated with a spectral reflectance of black color. In this example, the reflective layer 14 can move proximate to the optical stack 16, for example, distance between the reflective layer 14 and the optical stack 16 of about 0 nm.

Similar to subpixel 210, for subpixels 211 and 212, the first state can correspond to the relaxed position, the second state can correspond to the reverse-actuated position, and the third position can correspond to the actuated position. Also, the distance between the reflective layer 14 and the optical stack 16, for example, the gap size, may be different from the effective optical path length, L, for example, to compensate for material in the gap 19 and/or an insulating layer in the optical stack 16. Thus, subpixel 211 can have a first state associated with a spectral reflectance associated with a green color (with a gap size of about 164.2 nm), a second state associated with a spectral reflectance associated with a magenta color (with a gap size of about 282.5 nm), and a third state associated with a spectral reflectance of a black color (with a gap size of about 0 nm). Furthermore, subpixel 212 can have a first state associated with a spectral reflectance associated with a cyan color (with gap size of about 130.1 nm), a second state associated with a spectral reflectance associated with a red color (with a gap size of about 248.4 nm), and a third state associated with a spectral reflectance of a black color (with a gap size of about 0 nm).

As discussed above in relation to FIG. 11B, in order to form the gaps above and below the movable reflective layer 14 in the relaxed position (see FIG. 10A) for each of the subpixels depicted in FIG. 12A, a first sacrificial layer can be deposited, followed by the movable reflective layer 14, followed by a second sacrificial layer. As can be seen from FIG. 12A, forming subpixel 210 can include depositing a first sacrificial layer of about 223 nm, depositing the movable reflective layer 14, and depositing a second sacrificial layer of about 118 nm. Similarly, forming subpixels 211 and 212 can include depositing first sacrificial layers of about 164 nm and 130 nm, and depositing second sacrificial layers of about 118 nm for each of the subpixels. It is noted that in the pixel design of FIG. 12A, all of the second sacrificial layers can be about 118 nm. The first sacrificial layers can be deposited using three masks, while the second sacrificial layers can be deposited using only one mask. Since there are only four unique sacrificial layer thicknesses in the design of FIG. 12A, the six different gaps 19 for the three subpixels 210, 211 and 212, in some implementations a total of four masks can be used to deposit all of the sacrificial layers in the pixel design illustrated in FIG. 12A.

As shown in FIG. 12A, each subpixel 210, 211 and 212 (for example, in the first state) can have a spectral reflectance associated with a first set of primary colors. Also, each subpixel 210, 211 and 212 (for example, in the second state) can have a spectral reflectance associated with a second set of primary colors. At least one of the colors in the second set of primary colors can be different from the colors in the first set of primary colors. For example, the first set of primary colors in pixel 200 can include orange, green, and cyan, while the second set of primary colors in pixel 200 can include blue, magenta, and red.

FIG. 12B shows the spectral reflectances as a function of wavelength for the example pixel shown in FIG. 12A. For example, spectral reflectances 215, 216 and 217 can be associated with the first set of primary colors of orange, green, and cyan respectively. Likewise, spectral reflectances 225, 226 and 227 can be associated with the second set of primary colors of blue, magenta and red respectively.

In this example, all three colors of the first set of primary colors 215, 216 and 217 in pixel 200 are different from all three colors in the second set of primary colors 225, 226 and/or 227 in pixel 200. However, as mentioned herein, in some implementations, only at least one of the colors in the second set of primary colors may be different from the first set of primary colors. In the example shown in FIG. 12A, each of the colors in the first set of primary colors is also different from the other colors in the first set of primary colors. For example, each of the spectral reflectances 215, 216 and 217 for the first set of primary colors is different from each of the spectral reflectances 215, 216 and/or 217. Also, each of the colors in the second set of primary colors is different from the other colors in the second set of primary colors in this example. For example, each of the spectral reflectances of 225, 226 and 227 is different from each of the spectral reflectances of 225, 226 and/or 227. However, in other implementations, two or more colors in the first set of primary colors or two or more colors in the second set of primary colors may appear substantially the same.

In the example shown in FIG. 12A, when subpixels 210, 211 and 212 are all in the first state (such as the relaxed position in this example), the colors orange, green, and cyan can combine such that pixel 200 outputs a white color. In addition, the combination of colors of the first set of primary colors can have a brightness that is higher than a brightness of a combination of colors of the second set of primary colors. For example, in the implementation shown in FIG. 12A, the combination of the orange, green, such as a less saturated green than sRBG green, and cyan can have a higher brightness than a combination of colors using blue, magenta, and red. Thus, in certain implementations of a display device having a plurality of pixels 200 similar to the one shown and described in reference to FIG. 12A, the subpixels of at least one of the plurality of pixels 200 can be selectively switched to output a relatively brighter white (for example, in the first state) compared to when selectively switched to produce a white color using colors in the second set of primary colors (for example, in the second state).

As described herein, in some implementations, the first set of primary colors can be selected to increase the brightness of the display device as compared to a display device having only subpixels associated with the second set of primary colors. For example, the brightness of the combination of the colors of the first set of primary colors, such as simulated/modeled or measured as the reflectance of incident white light by the display, can be greater than the brightness using a combination of the second set of primary colors by at least about 150% to about 400%, e.g., by at least about 150%, by at least about 175%, by at least about 200%, by at least about 225%, by at least about 250%, by at least about 275%, by at least about 300%, by at least about 325%, by at least about 350%, by at least about 375%, or by at least about 400%. In certain implementations, luminance can be given in arbitrary units, which are useful for comparing display devices to each other. In the example of FIG. 12A, the luminance of the combination of the colors of the first set of primary colors can be about 110.4, while the luminance of the combination of the colors of the second set of primary colors can be about 30.8, for example, the combination of the first set of primary colors is about 258% brighter than the combination of the second set.

In the example shown in FIG. 12A, the second set of primary colors also can be selected to increase the color gamut of the display device as compared a display device having only subpixels associated with the first set of primary colors alone. FIG. 12C shows the chromaticity diagram that illustrates the colors that can be produced by the example pixel shown in FIG. 12A. Trace 240 can correspond to the range of colors that can be produced by the first set of primary colors corresponding to points 235 (orange), 236 (green) and 237 (cyan). Trace 250 can correspond to the range of colors that can be produced by the pixel 200 incorporating the second set of primary colors corresponding to points 245 (blue), 246 (magenta) and 247 (red) with the first set of primary colors. For example, trace 250 can correspond to the convex hull produced by points 235 (orange), 236 (green) and 237 (cyan), 245 (blue), 246 (magenta), and 247 (red). As shown in FIG. 12C, the total color gamut (for example, trace 250) is larger than the first color gamut (for example, trace 240).

Certain implementations of the display device using pixels as shown in FIGS. 12A-12C can simultaneously increase both the brightness and the color gamut of a display as compared to a display device using only one set of primary colors. For example, a display device can use at least one of a plurality of these pixels to output a relatively brighter white (or a color) compared to when the pixel is selectively switched to output white light (or light having a color) using colors in the second set of primary colors. As shown in FIG. 12C, the first set of primary colors, e.g., points 235 (orange), 236 (green), and 237 (cyan), lies closer to point 238 (white) than the second set of primary colors, e.g., points 245 (blue), 246 (magenta), and 247 (red). In addition, one or more subpixels of another one of these such pixels can be selectively switched to output a color outside the first color gamut (for example, in the second state to produce a color within trace 250 as opposed to only within trace 240).

In certain implementations, the second set of primary colors can form a second color gamut, for example, trace 251. The second color gamut can be greater than the first color gamut up to at least about 150%. In some implementations, the second color gamut can be greater than the first color gamut up to at least about 500%. For example the second color gamut can be greater than the first color gamut up to at least about 200%, up to at least about 250%, up to at least about 300%, up to at least about 350%, up to at least about 400%, or up to at least about 450%. In the example shown in FIG. 12C, the color gamut, for example, as determined as the area when compared to a standard color gamut or to a color gamut of another display device, formed by the blue, magenta, and red colors of the second set of primary colors can be about 15%, while the color gamut formed by the orange, green, and cyan colors of the first set of primary colors can be about 5.2%, for example, the second color gamut can be about 188% greater than the first color gamut. For this example, the total color gamut formed by the first and the second sets of primary colors can be about 50.4%, such as about 869% greater than the first color gamut and about 236% greater than the second color gamut. Also, in the example shown in FIG. 12C, the first color gamut and the second color gamut do not overlap. The total color gamut is larger than the combination (for example, sum) of the first color gamut and the second color gamut.

Certain implementations of the display device using pixels as shown in FIGS. 12A-12C also can simultaneously increase both the brightness and the color saturation of the display as compared to a display device using only one set of primary colors. For example, as discussed above, at least one subpixel can be selectively switched (such as to the second state) to output a color outside the first color gamut (e.g., blue, magenta, red, or some mixture thereof). In some implementations, the color outside the first color gamut can have a higher color saturation than when the subpixels of the pixel are selectively switched to output a similar hue using colors of the first set of primary colors (such as in the first state). Thus, when used in combination with subpixels selectively switched (such as to the first state) to increase brightness, certain implementations also can increase color saturation as compared to a display device using only one set of primary colors.

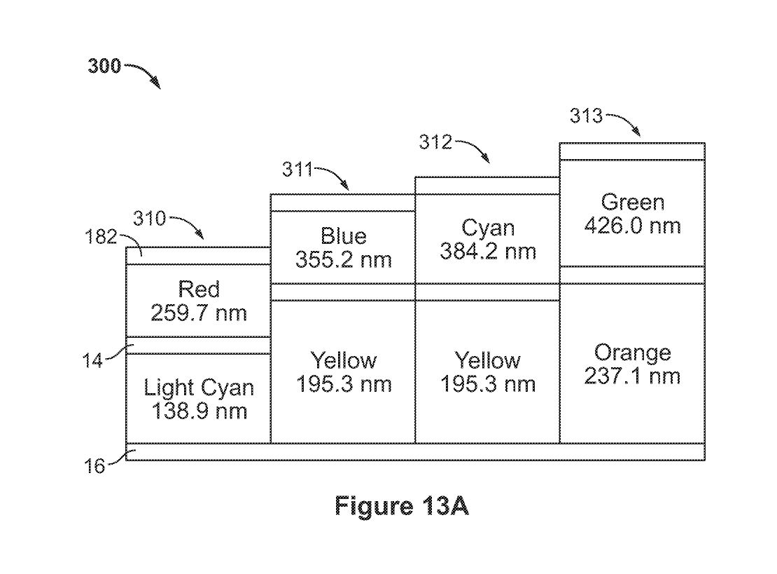

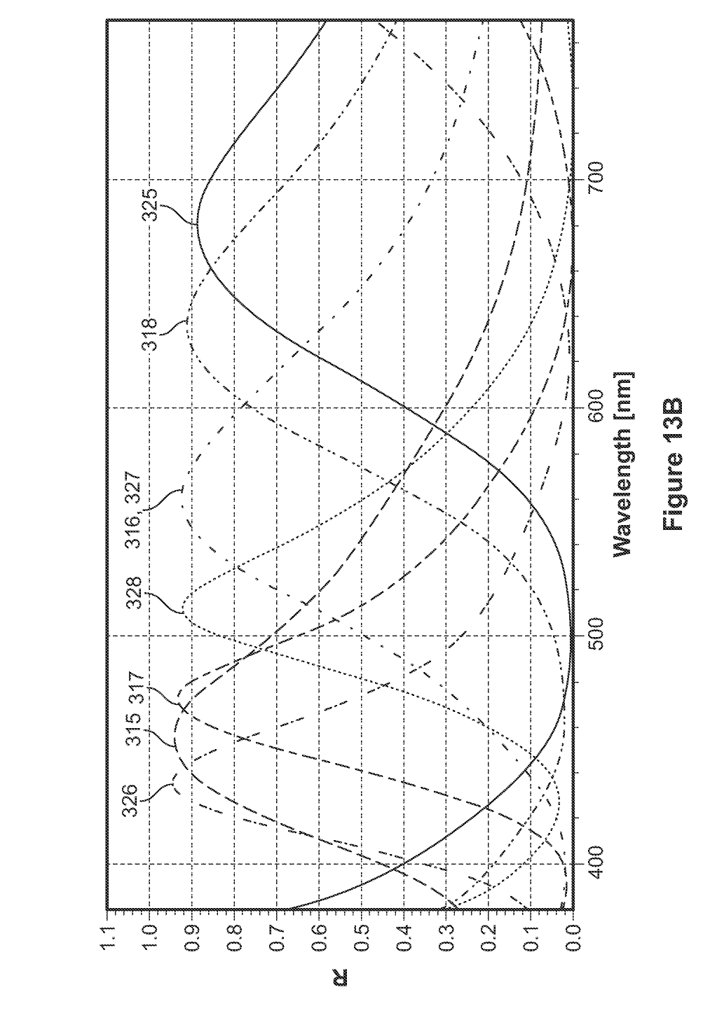

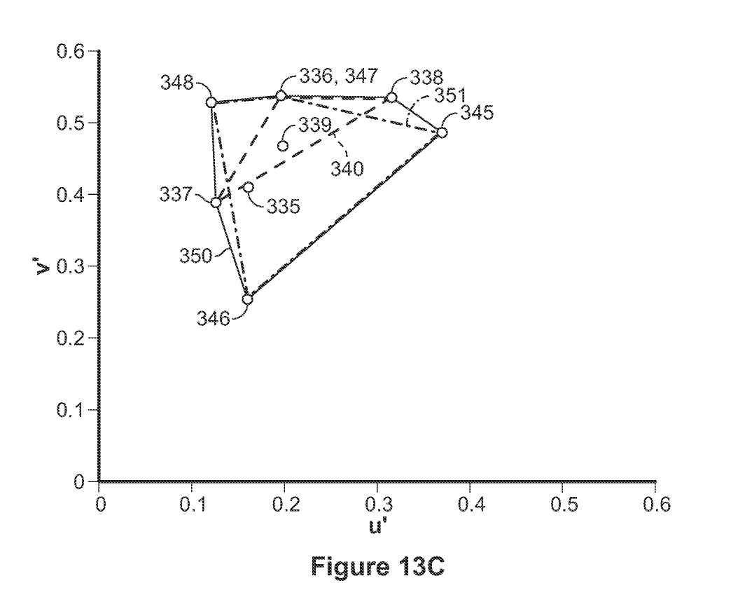

FIG. 13A schematically illustrates a side cross-sectional view of another example pixel. As shown in FIG. 13A, each pixel 300 can include a plurality of subpixels, for example, at least four subpixels 310, 311, 312 and 313. Similar to subpixel 200 of FIG. 12A, each subpixel 310, 311, 312 and 313 of pixel 300 can include an interferometric modulator 180 such as the example shown in FIGS. 10A-10C, e.g., including a movable reflective layer 14, an optical stack 16, and a bus stack 182. Each subpixel 310, 311, 312 and 313 can be configured to be selectively switched among a first state, a second state, and a third state. The subpixel 310 can have a first state associated with a spectral reflectance associated with a light cyan color (with a distance between the reflective layer 14 and the optical stack 16, or gap size, of about 138.9 nm), a second state associated with a spectral reflectance associated with a red color (with a gap size of about 259.7 nm), and a third state associated with a spectral reflectance of a black color (with a gap size of about 0 nm). For this example, the first state corresponds to the relaxed position, the second state corresponds to the reverse actuated position, and the third state corresponds to the actuated position of the subpixel 310.

As discussed above in relation to FIGS. 11B and 12A, in order to form the gaps above and below the movable reflective layer 14 in the relaxed position (see FIG. 10A) for each of the subpixels depicted in FIG. 13A, a first sacrificial layer can be deposited, followed by the movable reflective layer 14, followed by a second sacrificial layer. It is possible to achieve the gap spacings shown in FIG. 13A using first and second sacrificial layers having thicknesses chosen from the following thicknesses: 120.8 nm, 138.9 nm, 159.9 nm, 188.9 nm, 195.3 nm, and 237.1 nm. The first sacrificial layers can be deposited using three masks, and the second sacrificial layers can also be deposited using three masks. Although there are seven unique gap spacings shown in FIG. 13A, in some implementations a total of six masks can be used to deposit all of the sacrificial layers in the pixel design illustrated in FIG. 13A.

Likewise, subpixel 311 can have a first state associated with a spectral reflectance associated with a yellow color (with a gap size of about 195.3 nm), a second state associated with a spectral reflectance associated with a blue color (with a gap size of about 345.2 nm), and a third state associated with a spectral reflectance of a black color (with a gap size of about 0 nm). Similarly, subpixel 312 can have a first state associated with a spectral reflectance associated with a yellow color (with a gap size of about 195.3 nm), a second state associated with a spectral reflectance associated with a cyan color (with a gap size of about 348.4 nm), and a third state associated with a spectral reflectance of a black color (with a gap size of about 0 nm). In addition, subpixel 313 can have a first state associated with a spectral reflectance associated with an orange color (with a gap size of about 237.1 nm), a second state associated with a spectral reflectance associated with a green color (with a gap size of about 426.0 nm), and a third state associated with a spectral reflectance of a black color (with a gap size of about 0 nm). Thus, for each of subpixels 311, 312, and 313 in this example, the first state corresponds to the relaxed position, the second state corresponds to the reverse actuated position, and the third state corresponds to the actuated position.

FIG. 13A is an example pixel where the first set of primary colors and/or the second set of primary colors may include colors associated with a combination of relaxed and reverse-actuated positions. In the example pixel 300 in FIG. 13A, the subpixels 310, 311, 312 and 313 can have spectral reflectances associated with a first set of primary colors. The first set of primary colors can include light cyan, yellow, orange (e.g., associated with the relaxed positions in subpixels 310, 311, and 313 respectively), and cyan (such as associated with the reverse-actuated position in subpixel 312). The subpixels 310, 311, 312 and 313 also can have spectral reflectances associated with a second set of primary colors. The second set of primary colors can include red, blue, green (e.g., associated with the reverse-actuated positions in subpixels 310, 311, and 313 respectively), and yellow (such as associated with the relaxed position in subpixel 312).

FIG. 13B shows the spectral reflectances as a function of wavelength for the example pixel shown in FIG. 13A. For example, spectral reflectances 315, 316, 317, and 318 can be associated with the first set of primary colors of light cyan, yellow, cyan, and orange respectively. Likewise, spectral reflectances 325, 326, 327, and 328 can be associated with the second set of primary colors of red, blue, yellow, and green respectively.

FIG. 13A is also an example pixel where the colors within the first set of primary colors and the second set of primary colors may be the same, such as yellow in the first set of primary colors of subpixel 311 and yellow in the second set of primary colors of subpixel 312 as shown by the spectral curves 316 and 327 in FIG. 13B appearing substantially the same.

Although the first set of primary colors also includes a cyan hue in both subpixel 310 and 312, the colors are not considered the same because light cyan 315 (for example, in the relaxed position) of subpixel 310 is brighter than cyan 317 (for example, in the reverse-actuated position) of subpixel 312. For example, as in FIG. 13B, light cyan has a greater area under curve 315 than cyan has under curve 317.

FIG. 13C shows the chromaticity diagram that illustrates the colors that can be produced by the example pixel shown in FIG. 13A. In this example, the first set of primary colors (e.g., light cyan, yellow, cyan, and orange) forms a smaller color gamut and is less saturated than the total color gamut produced by incorporating the second set of primary colors (red, blue, yellow, and green). For example, trace 340 can indicate a range of colors that can be produced by the first set of primary colors corresponding to points 335 (light cyan), 337 (cyan), 336 (yellow), and 338 (orange). Trace 350 can indicate the range of colors that can be produced by the pixel 300 by incorporating the second set of primary colors corresponding to points 345 (red), 346 (blue) 347 (yellow), and 348 (green) with the first set of primary colors. For example, trace 350 can correspond to the convex hull produced by points 345 (red), 346 (blue), 337 (cyan), 348 (green), 336, 347 (yellow), and 338 (orange). As shown in FIG. 13C, the total color gamut (for example, trace 350) is larger than the first color gamut (for example, trace 340).

In this example, at least one color of the first set of primary colors lies outside the second color gamut formed by the second set of primary colors. For example as shown in FIG. 13C, point 337 for cyan of the first set of primary colors lies outside of a trace 351 surrounding the second color gamut of the second set of primary colors represented by points 345 (red), 346 (blue), 348 (green), and 347 (yellow). However, in this example, the second color gamut (for example, trace 351) and the total color gamut (for example, trace 350) are both larger than the first color gamut (for example, outlined by trace 340).

Certain implementations of a display device can have a plurality of pixels 300 as the one shown and described in reference to FIGS. 13A-13C. The subpixels of one or more pixels 300 can be selectively switched, e.g., subpixels 310, 311, 312 and 313 selectively switched to the first state (e.g., the relaxed position for subpixel 310, 311, and 313 and the reverse-actuated position for subpixel 312), to output the first set of primary colors. In addition, one or more of the subpixels 310, 311, 312, and 313 of another pixel 300 can be selectively switched to output a color using a combination of colors of the second set of primary colors (e.g., using the colors red, blue, yellow, and green). A combination of the first set of primary colors can have a higher brightness than a combination of colors of the second set of primary colors. As shown in FIG. 13C, the first set of primary colors (e.g., points 335, 337, 336, and 338) lies closer to point 339 (white) than the second set of primary colors (e.g., points 345, 346, 348, and 347). Thus, by using one or more pixels 300 to output white light (or light having a color) using the colors from the first set of primary colors in combination with one or more other pixels 300 outputting a color using a combination of colors of the second set of primary colors to output a color outside the first color gamut, the display device can simultaneously increase the brightness and the color gamut and/or the color saturation of a display as compared to a display device using only one set of primary colors.

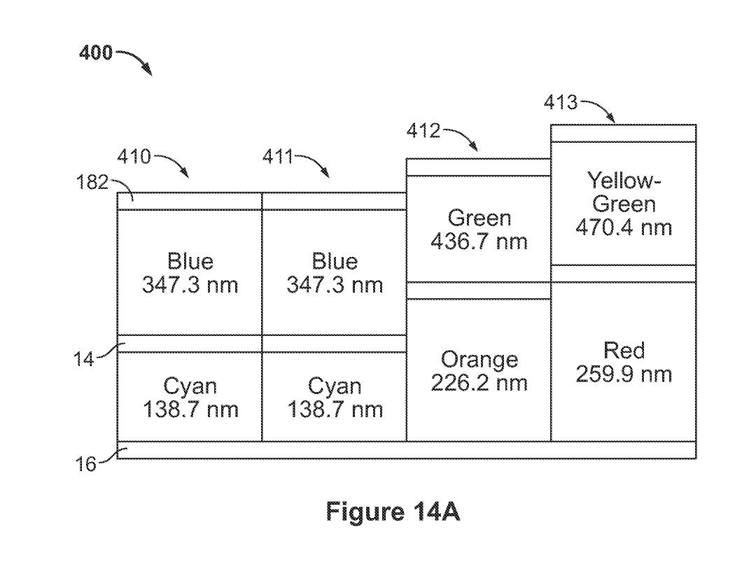

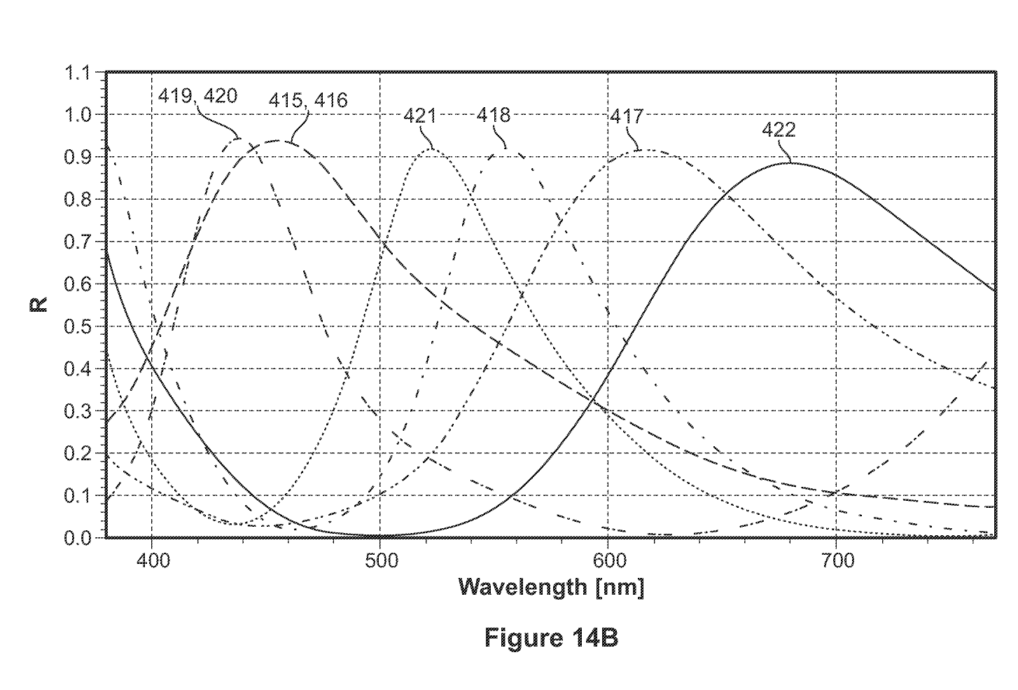

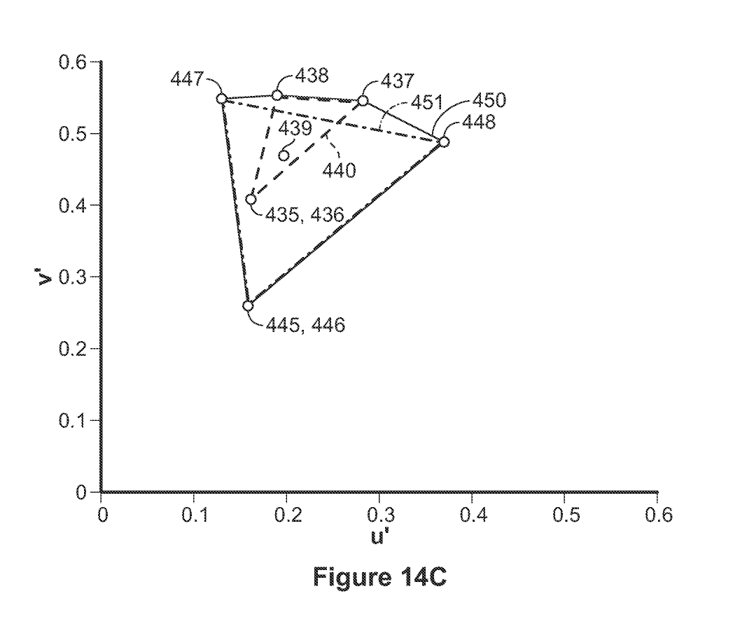

FIG. 14A schematically illustrates a side cross-sectional view of another example pixel. As shown in FIG. 14A, each pixel 400 can include a plurality of subpixels, for example, at least four subpixels 410, 411, 412 and 413. Similar to subpixel 200 of FIG. 12 and subpixel 300 of FIG. 13, each subpixel 410, 411, 412 and 413 of pixel 400 can include an interferometric modulator 180 such as the example shown in FIGS. 10A-10C, e.g., including a movable reflective layer 14, an optical stack 16, and a bus stack 182. Each subpixel 410, 411, 412 and 413 can be configured to be selectively switched among a first state, a second state, and a third state. If the first state corresponds to the relaxed position, the second state corresponds to the reverse actuated position, and the third state corresponds to the actuated position, both subpixels 410 and 411 can have a first state associated with a spectral reflectance associated with a cyan color (with a gap size, of about 138.7 nm), a second state associated with a spectral reflectance associated with a blue color (with a gap size of about 347.3 nm), and a third state associated with a spectral reflectance of a black color (with a gap size of about 0 nm).

As discussed above in relation to FIGS. 11B, 12A, and 13A, in order to form the gaps above and below the movable reflective layer 14 in the relaxed position (see FIG. 10A) for each of the subpixels depicted in FIG. 14A, a first sacrificial layer can be deposited, followed by the movable reflective layer 14, followed by a second sacrificial layer. It is possible to achieve the gap spacings shown in FIG. 14A using first and second sacrificial layers having a thickness chosen from the following thicknesses: 138.7 nm, 208.6 nm, 210.5 nm, 226.2 nm, and 259.9 nm. The first sacrificial layers can be deposited using three masks, and the second sacrificial layers can be deposited using two masks. Although there are six unique gap spacings shown in FIG. 14A, in some implementations a total of five masks can be used to deposit all of the sacrificial layers in the pixel design illustrated in FIG. 14A.

Likewise, subpixel 412 can have a first state associated with a spectral reflectance associated with an orange color (with a gap size of about 226.2 nm), a second state associated with a spectral reflectance associated with a green color (with a gap size of about 436.7 nm), and a third state associated with a spectral reflectance of a black color (with a gap size of about 0 nm). Similarly, subpixel 413 can have a first state associated with a spectral reflectance associated with a red color (with a gap size of about 259.9 nm), a second state associated with a spectral reflectance associated with a yellow-green color (with a gap size of about 470.4 nm), and a third state associated with a spectral reflectance of a black color (with a gap size of about 0 nm).

In the example pixel 400 in FIG. 14A, the subpixels 410, 411, 412 and 413 can have spectral reflectances associated with a first set of primary colors (e.g., cyan, cyan, and orange from subpixels 410, 411, and 412 respectively in the relaxed positions and yellow-green from subpixel 413 in the reverse-actuated position). The subpixels 410, 411, 412 and 413 also can have spectral reflectances associated with a second set of primary colors (e.g., blue, blue, and green from subpixels 410, 411 and 412 respectively in the reverse-actuation positions and red from subpixel 413 in the relaxed position).

FIG. 14B shows the spectral reflectances as a function of wavelength for the example pixel shown in FIG. 14A. For example, spectral reflectances 415, 416, 417 and 418 can be associated with the first set of primary colors of cyan, cyan, orange, and yellow-green respectively. Likewise, spectral reflectances 419, 420, 421 and 422 can be associated with the second set of primary colors of blue, blue, green, and red respectively.

As shown in FIG. 14B, FIG. 14A is an example pixel where the colors within either the first set of primary colors or the second set of primary colors may be the same, for example, cyan in the first set of primary colors of subpixels 410 and 411 (such as in the first state) as indicated by the spectral reflectances 415 and 416 being substantially the same; and blue in the second set of primary colors of subpixels 410 and 411 (such as in the second state) as indicated by the spectral reflectances 419 and 420 appearing substantially the same.

FIG. 14C shows the chromaticity diagram that illustrates the colors that can be produced by the example pixel shown in FIG. 14A. In this example, the first set of primary colors (e.g., cyan, cyan, orange and yellow-green) forms a smaller color gamut and is less saturated than the second set of primary colors (blue, blue, green and red). In addition, the total color gamut produced by incorporating the second set of primary colors can be larger than the color gamut produced by the first set of primary colors alone.

For example, trace 440 can indicate a range of colors that can be produced by the first set of primary colors corresponding to points 435 (cyan), 436 (cyan), 437 (orange), and 438 (yellow-green). Trace 450 can indicate the range of colors that can be produced by the pixel 400 by incorporating the second set of primary colors corresponding to points 445 (blue), 446 (blue), 447 (green), and 448 (red) with the first set of primary colors. As shown in FIG. 14C, trace 450 surrounds a larger area than trace 440 and thus the second set of primary colors contributes to a total color gamut larger than the color gamut achievable by the first set of primary colors alone. For example, trace 450 can correspond to the convex hull produced by points 445 (blue), 446 (blue), 447 (green), 438 (yellow-green), 437 (orange), and 448 (red). As shown in FIG. 14C, the total color gamut (for example, trace 450) can be larger than the first color gamut (for example, trace 440). In addition, in this example, trace 451 surrounding the second color gamut of the second set of primary colors represented by points 445 (blue), 446 (blue), 447 (green), and 448 (red) is also larger than the first color gamut (for example, outlined by trace 440.

In this example, the subpixels of one or more pixels 400 can be selectively switched, e.g., subpixels 410, 411 and 412 selectively switched to the relaxed position and subpixel 413 selectively switched to the reverse-actuated position, to output the first set of primary colors to output a relatively brighter white compared to when the subpixels 410, 411, 412 and 413 are selectively switched to output white using a combination of colors from the second set of primary colors. As shown in FIG. 14C, the first set of primary colors (e.g., points 435, 436, 437, and 438) lies closer to point 439 (white) than the second set of primary colors (e.g., points 445, 446, 447, and 448).

In addition, one or more of the subpixels 410, 411, 412 and 413 of another pixel 400 can be selectively switched to output a color using a combination of colors of the second set of primary colors (e.g., using the colors blue, blue, green and red). Since a combination of the first set of primary colors can have a higher brightness than a combination of colors of the second set of primary colors, by using one or more pixels to output white light (or light having a color) using the colors from the first set of primary colors in combination with one or more other pixels outputting a color using a combination of colors of the second set of primary colors to output a color outside the first color gamut, the display device can simultaneously increase the brightness and the color gamut and/or the color saturation of a display as compared to a display device using only one set of primary colors.

The example implementations described with reference to FIGS. 12A-14C are intended as illustrative, and not limiting. In some other implementations, any one of the first, second, and third states can be associated with other (non-white or non-black) colors (common or non-traditional), white color, or black color.

The example pixels shown in FIGS. 12A-14C have subpixels configured to produce a first color, a second color, and black. By having one state produce black, certain implementations can provide full color displays with a desired contrast ratio. However, in some implementations, it may be desirable to have subpixels configured to produce a first color, a second color, and a third color.

Full color displays are generally white or black in the off state. For example, displays having bi-stable interferometric modulators may be designed to be in the off state when in the relaxed position or the actuated position. So in an implementation where the bi-stable interferometric modulator is in a relaxed position when off (undriven), and is also configured so that the subpixels each reflect a given color when in the relaxed position (off), the color of the display when the display is off will be the color resulting from a combination of all of the colors reflected by the subpixels. In some implementations, for example, the subpixels may be red, blue, and green. In such an implementation, if the bi-stable interferometric modulator is configured to reflect when in a relaxed state and is relaxed when off, the display will have a white or gray color resulting from the additive contribution of all of the red, blue, and green subpixels. However, it is possible to configure a display so that it can have an arbitrary image when in the off state, rather than being all white or gray, for example. In one implementation, such a display can be achieved using tri-state interferometric modulators similar to those described above.

Certain implementations described herein can allow color or an image to be produced in the off state, yet capable of any image when in the on state that is not impacted by the off state color or image. For example, a pixel may include a plurality of subpixels (such as including multi-state or analog interferometric modulators). Each subpixel may be selectively switched among a first state, a second state, and a third state. Each state can be associated with either a color, a white color, or a black color. In certain implementations, if the relaxed position is the off state, any color or any image can be selected for the relaxed position. Since there are many different multi-state subpixels that can allow similar brightness and color gamut, different designs of these subpixels can be fabricated on the same display device. For example, generally speaking displays include an array of identically designed pixels. That is, the pixels are identical in the subpixel architecture that makes up each of the identical pixels. Hence, when in the off state, the pixels have an identical color, often a black color or a white color. But an image may be formed in the off state of a display if the display uses two different pixel designs. For example, one pixel design can be used in a spatial arrangement in the display as a background color, while the remainder of the display can be filled with a different pixel design to provide an image of a logo, for example.

This can be illustrated with reference to the tri-state interferometric pixel designs of FIGS. 13A and 14A. In the example of FIG. 13A, white can be formed by combining light cyan from subpixel 310 (relaxed), yellow from subpixel 311 (relaxed), cyan from subpixel 312 (reverse-actuated), and orange from subpixel 313 (relaxed). Since the implementation of FIG. 13A is designed so that white includes a combination of both relaxed and reverse-actuated subpixels, when all subpixels 310, 311, 312 and 313 are relaxed, the result is not a white color. For example, in FIG. 13A, if the subpixels are configured to be in a relaxed state when off, the off state color of the pixel 300 will not be white, but will have a yellow or yellow-orange hue. Similarly, in the example of FIG. 14A, white can be formed by combining cyan from subpixels 410 and 411 (relaxed), orange from subpixel 412 (relaxed), and yellow-green from pixel 413 (reverse-actuated). If the subpixels in the example of FIG. 14A are configured to be in a relaxed state when off, the off state color of the pixel 400 will not be white, but will have a redish hue. Hence, for example, a display that includes an array of pixels where some of the pixels are similar in design to the pixel design of FIG. 13A and others are similar to the pixel design of FIG. 14A is capable of displaying an image when off, where the image includes red and yellow colors in a spatial arrangement according to the spatial arrangement of the pixels having each design. In other implementations, more than two pixel designs may be used to provide for an off state image on the display that includes more than two colors. For example, if a third set of pixels have a design similar to FIG. 12A, and if the subpixels in the example of FIG. 12A are configured to be in a relaxed state when off, the off state color of pixel 200 will be a white color. Hence, as an example, a display can be implemented having an image including yellow, red, and white when the display is off and undriven.

If the overall or total gamuts of the two pixel designs are identical or identically overlap, the (arbitrary) image in the off state does not affect an arbitrary image that can be displayed when the display is turned on and driven. If the total gamuts are not identical, but substantially overlap, it is possible for an arbitrary image to be displayed when the display is turned on and driven with there being no residual affect of the off-state arbitrary image that is discernable to a human viewer. For example, the total color gamut in FIGS. 13C and 14C largely overlap, and such overlap can be sufficient for a viewer to see no discernable effect of the off-state arbitrary image on images displayed when the display is powered on.

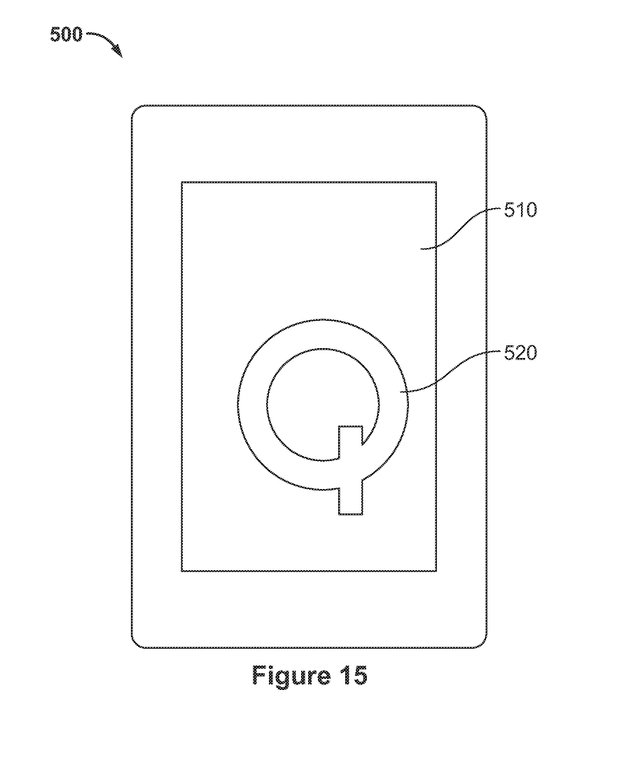

Hence a display can include an array of pixels, where some of the pixels in the array of pixels have a first pixel design and other pixels in the array of pixels have a second pixel design. The first pixel design outputs a first color when the display is in an off state and the second pixel design outputs a different second color when the display is in the off state. In some implementations, a spatial arrangement of the pixels having the first pixel design relative to the pixels having the second pixel design forms an off-state image on the display when the display is in an off state. FIG. 15 shows an example display device. For example, in display device 500, the array can be configured so that in a first region 510 of the array, the pixels are mostly from the first pixel design, while in a second region 520, the pixels are mostly from the second pixel design. As shown in FIG. 15, the first region 510 may display a background in colors, including non-white and non-black colors. In addition, the second region 520 may display an image, such as a logo, in colors, including non-white and non-black colors. In some implementations, the total color gamut of the first pixel design largely overlaps with the total color gamut of the second pixel design. In some implementations, no discernable effect of the off-state image remains once the display is powered on.

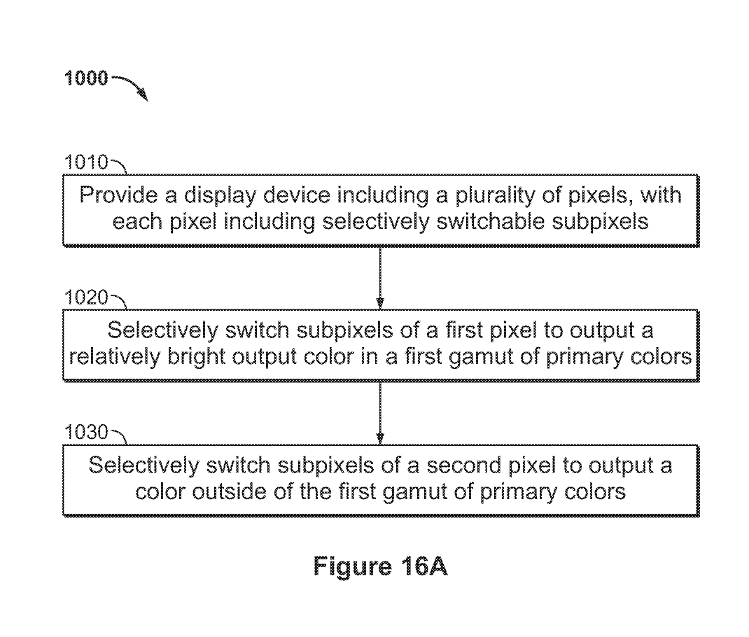

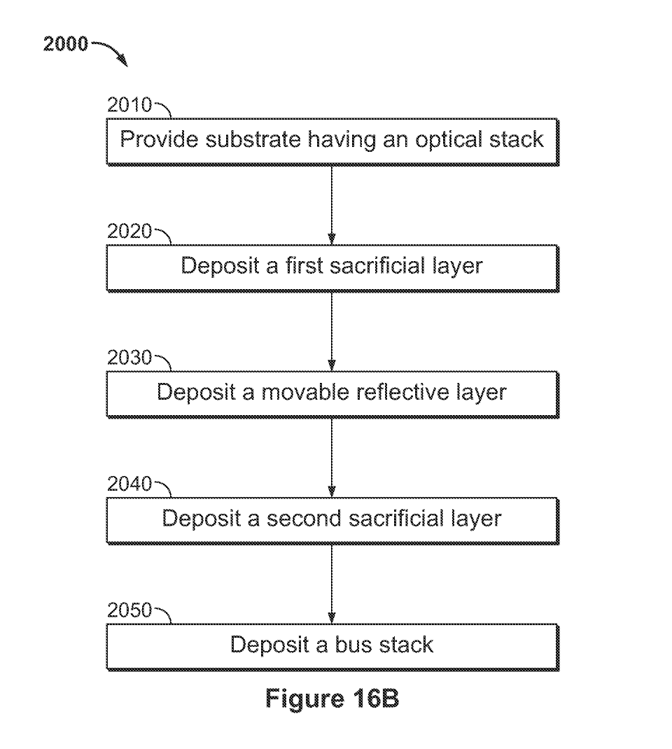

FIG. 16A is an example method of generating an image with a display device. As shown in block 1010, the method 1000 can include providing a display device including a plurality of pixels, with each pixel including selectively switchable subpixels. For example, in certain implementations the display device can include a plurality of reflective pixels. Each reflective pixel can include multiple subpixels configured to be selectively switched among a first state, a second state, and a third state. Each of the subpixels can have spectral reflectances associated with a first set of primary colors and a second set of primary colors. At least one color of the second set of primary colors can be different from the first set of primary colors. A combination of the colors of the first set of primary colors can have a higher brightness than a combination of the colors of the second set of primary colors.

As shown in block 1020, the method 1000 can include selectively switching subpixels of a first pixel to output a relatively bright output color in a first gamut of primary colors. For example, the method may include selectively switching subpixels of a first pixel to output a color of the first set of primary colors. The method 1000 further can include selectively switching subpixels of a second pixel to output a color outside of the first gamut of primary colors, as shown in block 1030. For example, the method can include selectively switching subpixels of a second pixel to output a color of the second set of primary colors to achieve a color outside of the gamut of the first set of primary colors.

FIG. 16B is an example method of fabricating a reflective pixel. The method 2000 can fabricate reflective pixels having subpixels, with each subpixel configured to be selectively switched among a first state, a second state, and a third state as described herein with respect to, e.g., FIGS. 11A, 11B, 12A, 13A, and/or 14A. In addition, the materials and processes can include those as discussed above with respect to FIGS. 7, 8A-8E, and 10A-10C. The method 2000 can include forming a first sacrificial layer over a substrate having an optical stack. For example, as shown in blocks 2010 and 2020 respectively, forming can include providing a substrate having an optical stack and depositing a first sacrificial layer. The method also can include forming a movable reflective layer (such as depositing a movable reflective layer as shown in block 2030) over the first sacrificial layer. The method 2000 further can include forming a second sacrificial layer over the movable reflective layer and forming a bus stack over the second sacrificial layer (such as depositing a second sacrificial layer and depositing a bus stack as shown in blocks 2040 and 2050 respectively). In some implementations, as discussed above with respect to FIGS. 11B, 12A, 13A, and 14A, forming (for example, depositing) a first sacrificial layer as shown in block 2020 can include using two or three masks to form first sacrificial layers of different thicknesses for different subpixels in the reflective pixel. Also as discussed above with respect to FIGS. 11B, 12A, 13A, and 14A, forming (for example, depositing) a second sacrificial layer as shown in block 2040 can include using one, two, or three masks to form second sacrificial layers of different thicknesses for different subpixels in the pixel. The method 2000 further can include removing the first and second sacrificial layers to provide gaps for each subpixel in the reflective pixel. Thus, all of the different gaps in certain implementations of reflective pixels having subpixels can be formed with six or fewer masks.

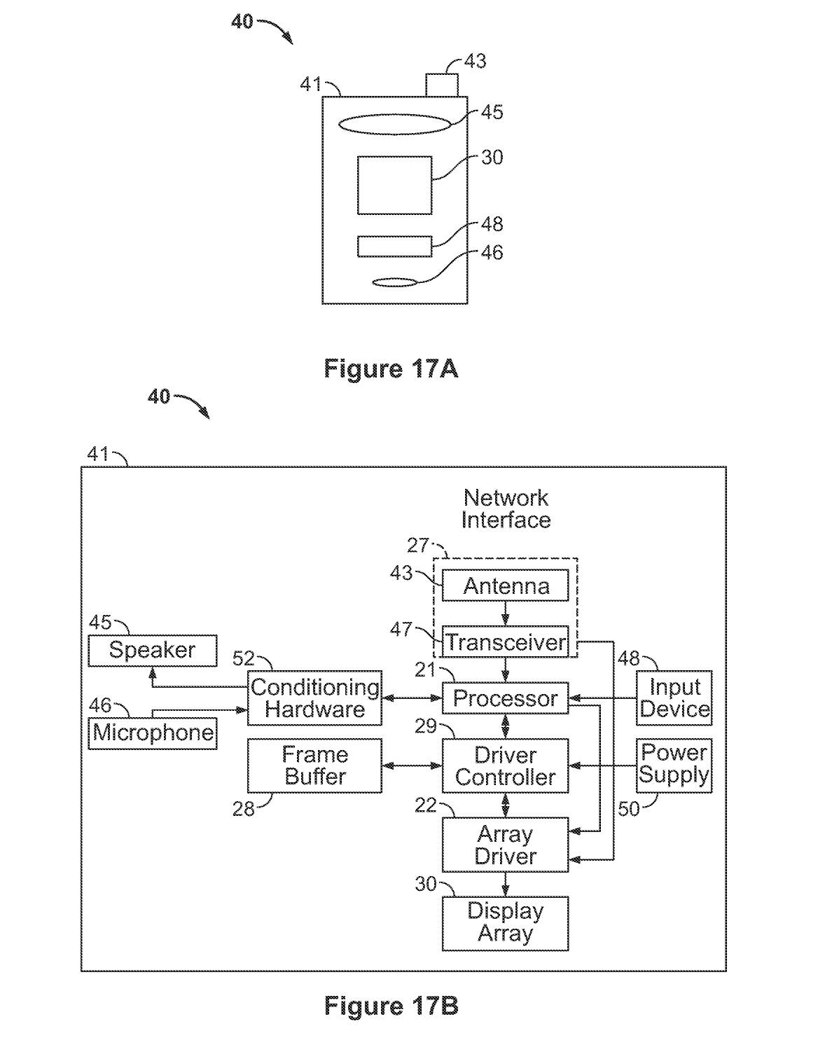

FIGS. 17A and 17B show examples of system block diagrams illustrating a display device 40 that includes a plurality of interferometric modulators. For example, the plurality of interferometric modulators can include an interferometric modulator 180 as shown in FIG. 1, 6A-6E, or 10A-10C. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players. The display device 500 (and components thereof) described with reference to FIG. 15 may be generally similar to the display device 40.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable, a multi-state, or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. In certain implementations, the display 30 can achieve both high reflectance and high color gamut.

The components of the display device 40 are schematically illustrated in FIG. 17B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (for example, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, hue, saturation, brightness, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller), or a multi-state display controller. Additionally, the array driver 22 can be a conventional driver, a bi-stable display driver (for example, an IMOD display driver), or a multi-state display controller. Moreover, the display array 30 can be a conventional display array, a bi-stable display array (for example, a display including an array of IMODs), or a multi-state display array. In some implementations, the driver controller 29 can be integrated with the array driver 22. Such an implementation can be useful in highly integrated systems, for example, mobile phones, portable-electronic devices, watches or small-area displays. In certain implementations, the processor 21, driver controller 29, the array driver 22, and the display array 30 are configured to drive the display elements (for example, multi-state interferometric modulators) among the various states to output colors in the first and/or second set of primary colors.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a plurality of reflective pixels, each reflective pixel including subpixels, each subpixel configured to be selectively switched among a first state, a second state, and a third state, each state having a different spectral reflectance,
wherein the subpixels have spectral reflectances associated with a first set of primary colors and the subpixels have spectral reflectances associated with a second set of primary colors, at least one of the colors in the second set of primary colors is different from the colors in the first set of primary colors,
wherein the first set of primary colors includes complementary colors that combine to produce white, and
wherein a combination of colors of the first set of primary colors has a brightness that is higher than a brightness of a combination of colors of the second set of primary colors.

2. The display device of claim 1, wherein the first set of primary colors is selected to increase brightness of the display device as compared to the second set of primary colors, and the second set of primary colors is selected to increase color gamut of the display device as compared to the first set of primary colors.

3. The display device of claim 1, wherein the brightness of the combination of the colors of the first set of primary colors is greater than the brightness of the combination of the second set of primary colors by about 150% to 400%.

4. The display device of claim 1, wherein the colors of the first set of primary colors form a first color gamut and the colors of the second set of primary colors form a second color gamut, and the second color gamut is larger than the first color gamut.

5. The display device of claim 1, wherein the second color gamut is greater than the first color gamut by about 150% to 500%.

6. The display device of claim 4, wherein at least one color of the first set of primary colors lies outside the second color gamut.

7. The display device of claim 1, wherein at least one pixel includes at least three or more subpixels.

8. The display device of claim 7, wherein the first set of primary colors includes cyan, desaturated green, and orange.

9. The display device of claim 1, wherein the subpixels in the first state and in the second state have spectral reflectances associated with either the first or second set of primary colors.

10. The display device of claim 1, wherein each subpixel in the first state has a different spectral reflectance associated with the first set of primary colors and each subpixel in the second state has a spectral reflectance associated with the second set of primary colors.

11. The display device of claim 1, wherein the subpixels in the third state have spectral reflectances associated with black.

12. The display device of claim 1, wherein each reflective subpixel includes an interferometric modulator.

13. The display device of claim 12, wherein the interferometric modulator includes:
a first reflector;
an electrode spaced from the first reflector by a first distance;
a second reflector disposed between the first reflector and the electrode, the second reflector movable between a relaxed position, an actuated position, and a reverse-actuated position,
wherein when in the actuated position, the second reflector is closer to the first reflector than when in the relaxed position, and
wherein when in the reverse-actuated position, the second reflector is farther from the first reflector than when in the relaxed position.

14. The display device of claim 13, wherein when in the relaxed position, the interferometric modulator reflects light associated with one of the colors of the first set of primary colors when the interferometric modulator is illuminated by broadband white light.

15. The display device of claim 13, wherein when in the reverse-actuated position, the interferometric modulator reflects light associated with one of the colors of the second set of primary colors when the interferometric modulator is illuminated by broadband white light.

16. The display device of claim 15, wherein at least one color of the second set of primary colors includes a second order color.

17. The display device of claim 1, further comprising:
a display including the plurality of reflective pixels;
a processor configured to communicate with the display, the processor being configured to process image data; and
a memory device configured to communicate with the processor.

18. The display device of claim 17, further comprising a driver circuit configured to send at least one signal to the display.

19. The display device of claim 18, further comprising a controller configured to send at least a portion of the image data to the driver circuit.

20. The display device of claim 17, further comprising an image source module configured to send the image data to the processor.

21. The display device of claim 20, wherein the image source module includes at least one of a receiver, a transceiver, and a transmitter.

22. The display device of 17, further comprising an input device configured to receive input data and to communicate the input data to the processor.

23. A display device comprising:
a plurality of reflective pixels, each reflective pixel including a plurality of tri-state means for reflecting three colors, the tri-state means configured to be selectively switched among a first state, a second state, and a third state, each state having a different color;
wherein the plurality of tri-state means has colors associated with a first set of primary colors and the plurality of tri-state means has colors associated with a second set of primary colors, at least one of the colors in the second set of primary colors is different from the colors in the first set of primary colors, the first set of primary colors includes complementary colors that combine to produce white, and
wherein a combination of the colors of the first set of primary colors has a higher brightness than a combination of the colors of the second set of primary colors.

24. The display device of claim 23, wherein the first set of primary colors is selected to increase brightness of the display device as compared to the second set of primary colors, and the second set of primary colors is selected to increase color gamut of the display device as compared to the first set of primary colors.

25. The display device of claim 23, wherein the colors of the first set of primary colors form a first color gamut and the colors of the second set of primary colors form a second color gamut, the second color gamut larger than the first color gamut.

26. The display device of claim 23,
wherein when the tri-state means are in the first state, the display device provides increased brightness relative to when the tri-state means are in the second state, and
wherein when the tri-state means are in the second state, the display device provides increased color gamut relative to when the tri-state means are in the first state.

27. The display device of claim 23, wherein the plurality of tri-state means includes interferometric modulators.

28. A method of generating an image with a display device, the display device including a plurality of reflective pixels, each reflective pixel including multiple subpixels configured to be selectively switched among a first state, a second state, and a third state, one of the first, second, and third states for each of the subpixels defining a first set of primary colors and an other of the first, second, and third states for each of the subpixels defining a second set of primary colors, at least one of the colors in the second set of primary colors is different from the colors in the first set of primary colors, wherein a combination of the colors of the first set of primary colors has a higher brightness than a combination of the colors of the second set of primary colors, the method comprising:
selectively switching the subpixels of a first pixel to output a color of the first set of primary colors to achieve a relatively bright output color; and
selectively switching the subpixels of a second pixel to output a color of the second set of primary colors to achieve a color outside of the gamut of the first set of primary colors.

29. The method of claim 28, wherein selectively switching the subpixels of the first pixel to the first state provides increased bright white relative to selectively switching the subpixels of the second pixel to the second state.

30. The method of claim 28, wherein the first set of primary colors includes cyan, desaturated green, and orange.

31. The method of claim 28, wherein the subpixels in the third state have spectral reflectances associated with black.

32. The method of claim 28, wherein at least one color of the second set of primary colors includes a second order color.

33. A method of fabricating a reflective pixel for a display device, the reflective pixel including multiple subpixels configured to be selectively switched among a first state, a second state, and a third state, one of the first, second, and third states for each of the subpixels defining a first set of primary colors and an other of the first, second, and third states for each of the subpixels defining a second set of primary colors, at least one of the colors in the second set of primary colors is different from the colors in the first set of primary colors, wherein a combination of the colors of the first set of primary colors has a higher brightness than a combination of the colors of the second set of primary colors, the method comprising:
forming a first sacrificial layer over a substrate having an optical stack;
forming a movable reflective layer over the first sacrificial layer;
forming a second sacrificial layer over the movable reflective layer; and
forming a bus stack over the second sacrificial layer.

34. The method of claim 33, wherein forming a first sacrificial layer includes using masks to form first sacrificial layers of different thicknesses for different subpixels in the reflective pixel.

35. The method of claim 34, wherein forming a second sacrificial layer includes using masks to form second sacrificial layers of different thicknesses for different subpixels in the reflective pixel.

36. The method of claim 35, further comprising removing the first sacrificial layer and the second sacrificial layer to provide gaps for each subpixel in the reflective pixel.

37. The method of claim 36, wherein forming the first sacrificial layer and forming the second sacrificial layer include using six or fewer masks for all the gaps in the reflective pixel.

38. A display device having an array of pixels, the array comprising:
a first plurality of pixels having a first pixel design; and
a second plurality of pixels having a second pixel design,
wherein the first pixel design is configured to output a first color when the display device is in an off state, and
the second pixel design is configured to output a second color different from the first color when the display device is in the off state.

39. The display device of claim 38, wherein the first plurality of pixels and the second plurality of pixels provide an off state image on the display device when the display device is in the off state.

40. The display device of claim 38, wherein the array includes a first region and a second region, the first region including only the first plurality of pixels and the second region including only the second plurality of pixels.

41. The display device of claim 38, wherein the first plurality of pixels has a first total color gamut and the second plurality of pixels has a second total color gamut, the first total color gamut substantially overlapping with the second total color gamut.

42. The display device of claim 39, wherein substantially no discernable effect of the off state image remains when the display device is in an on state.
